(19) United States
(12) Patent Application Publication
(10) Pub. No.: US 2019/0170849 A1
(43) Pub. Date: Jun. 6, 2019

(54) DETECTOR FOR AN OPTICAL DETECTION OF AT LEAST ONE OBJECT

(71) Applicant: trinamiX GmbH, Ludwigshafen am Rhein (DE)

(72) Inventors: Wilfried HERMES, Ludwigshafen (DE); Christoph LUNGENSCHMIED, Ludwigshafen (DE); Sebastian VALOUCH, Ludwigshafen (DE); Robert SEND, Ludwigshafen (DE); Ingmar BRUDER, Ludwigshafen (DE)

(73) Assignee: trinamiX GmbH, Ludwigshafen am Rhein (DE)

(21) Appl. No.: 16/321,054

(22) PCT Filed: Jul. 27, 2017
(86) PCT No.: PCT/EP2017/068957

§ 371 Date: Jan. 28, 2019

(30) Foreign Application Priority Data
Jul. 29, 2016 (EP) 16181974.3

(51) Int. Cl. G01S 3/781; G01S 17/48; G01S 3/782; G01S 7/481; G06F 3/03

(52) U.S. Cl. CPC G01S 3/781; G01S 17/48; G06F 3/0325; G01S 7/4816; G01S 3/782

(57) ABSTRACT

A detector for optical detection of at least one object includes: at least one longitudinal optical sensor including at least one sensor region, and configured to generate at least one longitudinal sensor signal dependent on an illumination of the sensor region by a light beam, wherein the longitudinal sensor signal, given same total power of the illumination, is dependent on a beam cross-section of the light beam in the sensor region, wherein the sensor region includes at least one thermoelectric unit configured, upon illumination of the sensor region or a part thereof by the light beam, to generate the longitudinal sensor signal resulting from at least one of a spatial variation or a temporal variation of a temperature in the thermoelectric unit; and at least one evaluation device configured to generate at least one item of information on a longitudinal position of the object by evaluating the longitudinal sensor signal.

### FIELD OF THE INVENTION

The invention relates to a detector for an optical detection of at least one object, in particular, for determining a position of at least one object, specifically with regard to a depth, a width, or both to the depth and a width of the at least one object. Furthermore, the invention relates to a human-machine interface, an entertainment device, a scanning system, a tracking system, a stereoscopic system; and a camera. Further, the invention relates to a method for optical detection of at least one object and to various uses of the detector. Such devices, methods and uses can be employed for example in various areas of daily life, gaming, traffic technology, mapping of spaces, production technology, security technology, medical technology or in the sciences. However, further applications are possible.

### PRIOR ART

Various detectors for optically detecting at least one object are known on the basis of optical sensors.

WO 2012/110924 A1 discloses a detector comprising at least one optical sensor, wherein the optical sensor exhibits at least one sensor region. Herein, the optical sensor is designed to generate at least one sensor signal in a manner dependent on an illumination of the sensor region. According to the so-called “FiP effect”, the sensor signal, given the same total power of the illumination, is hereby dependent on a geometry of the illumination, in particular on a beam cross-section of the illumination on the sensor region. The detector furthermore has at least one evaluation device designated to generate at least one item of geometrical information from the sensor signal, in particular at least one item of geometrical information about the illumination and/or the object.

WO 2014/097181 A1 discloses a method and a detector for determining a position of at least one object, by using at least one transversal optical sensor and at least one longitudinal optical sensor. Preferably, a stack of longitudinal optical sensors is employed, in particular to determine a longitudinal position of the object with a high degree of accuracy and without ambiguity. Further, WO 2014/097181 A1 discloses a human-machine interface, an entertainment device, a tracking system, and a camera, each comprising at least one such detector for determining a position of at least one object.

WO 2014/198629 A1 discloses a detector for determining a position of at least one object comprising at least one longitudinal optical sensor, the optical sensor being adapted to detect a light beam traveling from the object towards the detector. Herein, the longitudinal optical sensor has at least one matrix of pixels and at least one evaluation device, the evaluation device being adapted to determine a number N of pixels of the optical sensor which are illuminated by the light beam, the evaluation device further being adapted to determine at least one longitudinal coordinate of the object by using the number N of pixels which are illuminated by the light beam.

WO 2016/120392 A1, the full content of which is herewith included by reference, discloses further kinds of materials which are suitable as longitudinal optical sensor. Herein, a sensor region of the longitudinal optical sensor comprises a photoconductive material, wherein an electrical conductivity in the photoconductive material, given the same total power of the illumination, is dependent on the beam cross-section of the light beam in the sensor region. Thus, the longitudinal sensor signal is dependent on the electrical conductivity of the photo-conductive material. Preferably, the photoconductive material is selected from lead sulfide (PbS), lead selenide (PbSe), lead telluride (PbTe), cadmium telluride (CdTe), indium phosphide (InP), cadmium sulfide (CdS), cadmium selenide (CdSe), indium antimonide (InSb), mercury cadmium telluride (HgCdTe; MCT), copper indium sulfide (CIS), copper indium gallium selenide (CIGS), zinc sulfide (ZnS), zinc selenide (ZnSe), or copper zinc tin sulfide (CZTS). Further, solid solutions and/or doped variants thereof are also feasible. Further, a transversal optical sensor having a sensor area is disclosed, wherein the sensor area comprises a layer of the photoconductive material, preferentially embedded in between two layers of a transparent conducting oxide, and at least two electrodes. Preferably, at least one of the electrodes is a split electrode having at least two partial electrodes, wherein transversal sensor signals provided by the partial electrodes indicate an x- and/or a y-position of the incident light beam within the sensor area. Further, a longitudinal optical sensor is disclosed which is designed in such a way that the illumination of the sensor region by the light beam additionally causes an increase in temperature in the sensor region, wherein the electrical conductivity of the sensor region, given the same total power of the illumination, is further dependent on the temperature in the sensor region, wherein the longitudinal sensor signal, given the same total power of the illumination, is further dependent on the temperature in the sensor region. For this purpose, the sensor region comprises an inorganic photoconductive material, such as mentioned above. Thus, the longitudinal optical sensor, which also may be denominated as “bolometer” or, if having a lateral size in the micrometer range, as “micro-bolometer”, is sensitive to heat radiation, i.e. to a wavelength of the light beam in the infrared spectral range, in particular from 5 μm to 15 μm.

EP 1 947 477 A1 discloses an optoelectronic sensor having a light transmitter and a local resolution optoreceiver, wherein an examining unit is adapted for determining a distance of the object, particularly a diameter of a light spot on the optoreceiver, by employing triangulation.

Despite the advantages implied by the above-mentioned devices and detectors, there still is a need for improvements with respect to a simple, cost-efficient and, still, reliable spatial detector.

### Problem Addressed by the Invention

Therefore, a problem addressed by the present invention is that of specifying a device and a method for optically detecting at least one object which at least substantially avoid the disadvantages of known devices and methods of this type. In particular, a simple, cost-efficient and, still, reliable spatial detector for determining the position of an object in space by using light beams over a wide spectral range from the ultraviolet to the far infrared spectral range, in particular including the mid-infrared spectral range, would be desirable.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A.

In a first aspect of the present invention, a detector for optical detection, in particular, for determining a position of at least one object, specifically with regard to a depth or to both the depth and a width of the at least one object is disclosed.

The “object” generally may be an arbitrary object, chosen from a living object and a non-living object. Thus, as an example, the at least one object may comprise one or more articles and/or one or more parts of an article. Additionally or alternatively, the object may be or may comprise one or more living beings and/or one or more parts thereof, such as one or more body parts of a human being, e.g. a user, and/or an animal.

As used herein, a “position” generally refers to an arbitrary item of information on a location and/or orientation of the object in space. For this purpose, as an example, one or more coordinate systems may be used, and the position of the object may be determined by using one, two, three or more coordinates. As an example, one or more Cartesian coordinate systems and/or other types of coordinate systems may be used. In one example, the coordinate system may be a coordinate system of the detector in which the detector has a predetermined position and/or orientation. As will be outlined in further detail below, the detector may have an optical axis, which may constitute a main direction of view of the detector. The optical axis may form an axis of the coordinate system, such as a z-axis. Further, one or more additional axes may be provided, preferably perpendicular to the z-axis.

Thus, as an example, the detector may constitute a coordinate system in which the optical axis forms the z-axis and in which, additionally, an x-axis and a y-axis may be provided which are perpendicular to the z-axis and which are perpendicular to each other. As an example, the detector and/or a part of the detector may rest at a specific point in this coordinate system, such as at the origin of this coordinate system. In this coordinate system, a direction parallel or antiparallel to the z-axis may be regarded as a longitudinal direction, and a coordinate along the z-axis may be considered a longitudinal coordinate. An arbitrary direction perpendicular to the longitudinal direction may be considered a transversal direction, and an x- and/or y-coordinate may be considered a transversal coordinate.

Alternatively, other types of coordinate systems may be used. Thus, as an example, a polar coordinate system may be used in which the optical axis forms a z-axis and in which a distance from the z-axis and a polar angle may be used as additional coordinates. Again, a direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

As used herein, the detector for optical detection generally is a device which is adapted for providing at least one item of information on the position of the at least one object. The detector may be a stationary device or a mobile device. Further, the detector may be a stand-alone device or may form part of another device, such as a computer, a vehicle or any other device. Further, the detector may be a hand-held device. Other embodiments of the detector are feasible.

The detector may be adapted to provide the at least one item of information on the position of the at least one object in any feasible way. Thus, the information may e.g. be provided electronically, visually, acoustically or in any arbitrary combination thereof. The information may further be stored in a data storage of the detector or a separate device and/or may be provided via at least one interface, such as a wireless interface and/or a wire-bound interface.

The detector for an optical detection of at least one object according to the present invention comprises:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, is dependent on a beam cross-section of the light beam in the sensor region, wherein the sensor region is or comprises at least one thermoelectric unit, wherein the thermoelectric unit is designed, upon illumination of the sensor region or a partition thereof by the light beam, to generate the longitudinal sensor signal as a result of at least one of a spatial variation or a temporal variation of a temperature in the thermoelectric unit; and
at least one evaluation device, wherein the evaluation device is designed to generate at least one item of information on a longitudinal position of the object by evaluating the longitudinal sensor signal.

Herein, the components listed above may be separate components. Alternatively, two or more of the components as listed above may be integrated into one component. Further, the at least one evaluation device may be formed as a separate evaluation device independent from the transfer device and the longitudinal optical sensors, but may preferably be connected to the longitudinal optical sensors in order to receive the longitudinal sensor signal. Alternatively, the at least one evaluation device may fully or partially be integrated into the longitudinal optical sensors.

As used herein, the “longitudinal optical sensor” is generally a device which is designed to generate at least one longitudinal sensor signal in a manner dependent on an illumination of the sensor region by the light beam, wherein the longitudinal sensor signal, given the same total power of the illumination, is dependent, according to the so-called “FiP effect” on a beam cross-section of the light beam in the sensor region. The longitudinal sensor signal may generally be an arbitrary signal indicative of the longitudinal position, which may also be denoted as a depth. As an example, the longitudinal sensor signal may be or may comprise a digital and/or an analog signal. As an example, the longitudinal sensor signal may be or may comprise a voltage signal and/or a current signal. Additionally or alternatively, the longitudinal sensor signal may be or may comprise digital data. The longitudinal sensor signal may comprise a single signal value and/or a series of signal values. The longitudinal sensor signal may further comprise an arbitrary signal which is derived by combining two or more individual signals, such as by averaging two or more signals and/or by forming a quotient of two or more signals. For potential embodiments of the longitudinal optical sensor and the longitudinal sensor signal, reference may be made to the optical sensor as disclosed in WO 2012/110924 A1.

Similarly, a “transversal optical sensor” may, thus, refer to a device being adapted to determine a transversal position of at least one light beam traveling from the object to the detector. With regard to the term position, reference may be made to the definition above. Preferably, the transversal position may be or may comprise at least one coordinate in at least one dimension perpendicular to an optical axis of the detector. As an example, the transversal position may be a position of a light spot generated by the light beam in a plane perpendicular to the optical axis, such as on a light-sensitive sensor surface of the transversal optical sensor. As an example, the position in the plane may be given in Cartesian coordinates and/or polar coordinates. Other embodiments are feasible. For potential embodiments of the transversal optical sensor, reference may be made to WO 2014/097181 A1. However, other embodiments are feasible and will be outlined in further detail below.

Herein, the at least one longitudinal optical sensor exhibits at least one sensor region. Similarly, the transversal optical sensor may, equally, exhibit at least one sensor region. According to the present invention, the sensor region is or comprises at least one thermoelectric unit. As used herein, the term “thermoelectric unit” refers to a device, which is designed to generate the longitudinal sensor signal in consequence of at least one variation of a temperature in the thermoelectric unit upon illumination of the sensor region by a light beam. In this regard, it may be emphasized that the statement that the longitudinal sensor signal is obtained as a result of the variation of the temperature in the thermoelectric unit means that, in an event in which the temperature in the thermoelectric unit may remain constant, no longitudinal sensor signal can be observed. Consequently, the principle of operation of the thermoelectric unit differs from the operation of a bolometer which is designed to provide a sensor signal as a result of a change in resistance of a photoconductive material comprised by the bolometer while the thermoelectric unit as employed here is designed to rely on the change of the temperature. In accordance with the present invention, the variation of the temperature in the thermoelectric unit refers to one of a temporal variation of the temperature and a spatial variation of the temperature. As used herein, the term “temporal variation” refers to a change which may be detectable within the thermoelectric unit over a time interval while the term “spatial variation” relates to a change that may be observable at different locations within a volume of the thermoelectric unit at a specific point in time. Herein, both the temporal variation and the spatial variation of the temperature may also be observable, i.e. a change that may be observable at different locations within the volume of the thermoelectric unit which may itself vary over a time interval.

Generally, the thermoelectric unit may assume any embodiment that may be appropriate for being used as the sensor region of the longitudinal optical sensor or, if appropriate, of the transversal optical sensor. Preferably, the thermoelectric unit may, thus, comprise at least one of a thermoelectric material or a thermoelectric device. As used herein, the term “thermoelectric material” relates to a body comprising a substance being designed to generate the longitudinal sensor signal in consequence of varying the temperature upon illumination of the substance or a partition thereof by the light beam. In a particularly preferred embodiment, the thermoelectric material may comprise at least one pyroelectric material, which is described below in more detail. Similarly, the term “thermoelectric device” refers to a device being designed to generate the longitudinal sensor signal as a result of a variation of the temperature upon illumination of the device or, preferably, a partition thereof by the light beam. In a preferred embodiment, the thermoelectric device may comprise at least one thermocouple. Preferably, the thermoelectric device may comprise at least two thermocouples which are arranged in series. In a particularly preferred embodiment, the thermoelectric device may comprise a multitude of thermocouples which are arranged in series. This kind of thermoelectric device may also be denominated as a “thermopile”. In particular, the thermopile may comprise 2 to 1000, preferably 5 to 500, most preferred 10 to 120, thermocouples.

As mentioned above, the thermoelectric material may, in a particularly preferred embodiment, comprise the at least one pyroelectric material. As generally used, the term “pyroelectric material” relates to a material, in particular to a material comprising a polar crystalline structure, being capable of generating a temporary voltage as a result of a temperature variation, i.e. by heating or cooling the substance over a time interval. Not being bound by theory, the temperature variation may slightly modify positions of atoms being located within the polar crystal structure in a fashion that a polarization of the pyroelectric material may be altered, which, in turn, may result in an observation of the temporary voltage across the polar crystal. After the temperature has assumed a new constant value, the temporary voltage may gradually decrease, probably due to an occurrence of leakage currents, until it may eventually disappear. In this regard, it may be mentioned that the temporary voltage may be observable across the polar crystal comprising the pyroelectric material upon a temporal variation of the temperature of a whole body of the polar crystal. Strictly speaking, the occurrence of this phenomenon may not require a spatial variation of the temperature over a partition of the body of the polar crystal. However, an appearance of an additional spatial variation of the temperature over a partition of the body of the polar crystal upon the variation of the temperature may, thus, lead to a further effect that may, furthermore, occur and, if appropriate, be detectable. Consequently, the temporal variation of the temperature in the pyroelectric material may be designed to generate the desired sensor signal, in particular, the longitudinal sensor signal or, if applicable, the transversal sensor signal. As a result, the sensor signal may, thus, comprise a change in a voltage across the pyroelectric material which may, in particular, exhibit a relationship, preferably a linear relationship, to an extent of the temporal variation of the temperature which, in turn, may exhibit a relationship, preferably also a linear relationship, to the illumination of the sensor region comprising the pyroelectric material. However, other kinds of relationships, such as an exponential relationship, may also be feasible.

As generally known, only ten out of 32 crystal classes, i.e. the crystal classes which are usually denominated as 1, 2, m, mm2, 3, 3 m, 4, 4 mm, 6, and 6 mm, appear to be suitable for comprising naturally occurring pyroelectric crystalline materials which, without being subject to any perturbation, may not exhibit a net dipole moment. Thus, polar crystals may only reveal their pyroelectric nature when perturbed by a variation of the temperature designed to temporarily disturb a sophisticated balance within the crystal body. In addition, artificial materials in form of thin films have been provided which may exhibit pyroelectric properties. Thus, the pyroelectric material being particularly suitable for the present invention may, preferably, comprise at least one of an inorganic pyroelectric material or an organic pyroelectric substance. Herein, the inorganic pyroelectric material may, especially, be or comprise at least one of lithium tantalate (LiTaO₃), gallium nitride (GaN), cesium nitrate (CsNO₃), lead zirconate titanate (Pb[ZrₓTi₁₋ₓ]O3, wherein 0<x<1; PZT), mixtures and/or doped variants thereof. Further, the organic pyroelectric substance may, in particular, be or comprise at least one of a polyvinyl fluoride, a phenylpyridine derivatives, cobalt phthalocyanine, L-alanine, triglycine sulfate, mixtures and/or doped variants thereof. With regard to the mentioned pyroelectric materials, providing the pyroelectric material in form of a layer may, particularly, be preferred. Herein, the layer of the pyroelectric material may, especially, exhibit a thickness from 1 nm to 2 mm, preferably from 2 nm to 1 mm, more preferred from 2 nm to 0.5 mm. As a result, the pyroelectric material may be designed to generate the longitudinal sensor signal upon the illumination of the sensor region by the light beam, wherein the light beam may, preferably, have a wavelength from 1.5 μm to 30 μm, preferably from 2 μm to 20 μm, thus, allowing the detector to detect electromagnetic radiation in the mid-IR spectral range.

Further, the detector according to the present invention may comprise at least two electrodes being designed to contact the layer of the pyroelectric material, wherein the at least two electrodes may, preferably, be applied at different locations of the layer, in particular, to ensure that they may not contact each other directly. In a preferred embodiment, the electrodes may be applied to the same side of the layer. Irrespective of their detailed arrangement, the electrodes may, particularly, be designed to provide the sensor signal, i.e. the longitudinal sensor signal or, if appropriate, the transversal sensor signal, preferably, to the evaluation device, such as for further processing.

In a particular embodiment, the at least one layer of the pyroelectric material may, directly or indirectly, be applied to at least one substrate, wherein the substrate may be an electrically insulating substrate. In particular, in order to allow illuminating the sensor region comprising the pyroelectric material, the substrate may, fully or partially, be transparent or translucent, especially, over a wavelength from 1.5 μm to 30 μm, preferably from 2 μm to 20 μm.

As mentioned above, the thermoelectric device may, in a particularly preferred embodiment, comprise the at least one thermocouple, more preferred, at least two of the thermocouples, mostly preferred a multitude of the thermocouples, wherein the at least two thermocouples, in particular, the multitude of the thermocouples, is arranged in series. As already indicated, the multitude of the thermocouples, wherein the multitude of the thermocouples is arranged in series, may also be denominated as a “thermopile”. Preferably, the thermopile comprises 2 to 1000 thermocouples, preferably 5 to 500 thermocouples, most preferred 10 to 120 thermocouples. As generally used, the term “thermocouple” refers to arrangement comprising at least two different kinds of electrical conductors, wherein the different kinds of the electrical conductors are designed to form at least two spatially separated electrical junctions. Herein, an occurrence of a temperature difference between the spatially separated electrical junctions, a voltage may be generated between the spatially separated electrical junctions. Thus, the spatial variation of the temperature in the at least thermocouple may, in particular, be designed to generate the longitudinal sensor signal, preferably, in a manner that the longitudinal sensor signal may comprise an output voltage which may, in particular, exhibit a relationship, preferably a linear relationship, to an extent of the spatial variation of the temperature in the at least thermocouple, i.e. between the different kinds of the electrical conductors spatially separated from each other. However, other kinds of relationships, such as an exponential relationship, may also be feasible. As used herein, the spatial variation of the temperature in the at least thermocouple may comprise a local temperature difference or a temperature gradient, in particular, between the different kinds of the electrical conductors which may be spatially separated from each other. Thus, as explicitly expressed in Wikipedia, Article denoted “Thermocouple”, retrieved Jul. 20, 2016, the principle of operation of a thermopile sensor is distinct from that of a bolometer, as the latter relies on a change in resistance.

In a preferred embodiment of the thermoelectric device, in particular, of the thermopile the one or more thermocouples are arranged within the sensor region in fashion that the light beam may be designed to illuminate only the first kind of the electrical conductors, also denoted as a “hot junction” while the second kind of the electrical conductors, also denominated as a “cold junction”, may be designed to receive less illumination, preferably no illumination, from the incident light beam. While, in this preferred embodiment, the first kind of the electrical conductors, i.e. the hot junction, may be coated with an energy absorber suspended on a thin membrane and thermally isolated from a substrate, also denominated as “detector package”, partially covering the at least one optical sensor, the second kind of the electrical conductors, i.e. the cold junction, may, preferably connected to a heat sink, wherein the substrate or a partition thereof may, especially, be or comprise the heat sink. In this embodiment, the longitudinal sensor signal may comprise an output voltage that may occur between the hot junction, i.e. the first kind of the electrical conductors, and the cold junction, i.e. the second kind of the electrical conductors in the thermocouple. Herein, the output voltage may, in particular, exhibit a relationship, preferably a linear relationship, i.e. be proportional, to the variation of the temperature between the hot junction and the cold junction in the thermocouple.

In a particularly preferred embodiment, the electrical conductors as comprised by the one or more thermocouples may comprise a thin film of an electrically conducting material. Herein, he sensor region of the at least one thermocouple may exhibit an active area from 0.01 mm² to 100 mm², preferably from 0.03 mm² to 30 mm². In this regard, the electrical conductors, particularly, exhibit an arrangement, also denominated as “arms” in which an n-type conducting material and a p-type conducting material are located in an alternating fashion. In particular, the n-type conducting material may comprise at least one of Sb or n-type Si while the p-type conducting material may comprise at least one of Bi, Au, Al, or p-type Si. By way of example, electrical conductors of Sb and Bi may alternatingly be arranged along the series of the thermocouples in the thermopile. In a further example, the series of the thermocouples in the thermopile may comprise two arms alternatingly comprising n-type Si as the n-type conducting material and one of p-type Si, Au or Al as the p-type conducting material.

As a result, the thermoelectric device which, in particular, comprises the one or more thermocouples, preferably the thermopile, may, thus, be designed to generate the longitudinal sensor signal upon the illumination of the sensor region by the light beam, wherein the thermocouples may be capable of detecting electromagnetic radiation in at least one of the UV, visible, NIR, mid-IR or FIR spectral ranges, preferably in at least two of the UV, visible, NIR, mid-IR or FIR spectral ranges, mostly preferred in all of the UV, visible, NIR, mid-IR or FIR spectral ranges. In particular, the one or more thermocouples, preferably the thermopile, may exhibit a flat response to the electromagnetic radiation over the complete spectral range from the UV to the FIR. As used herein, the term “flat response” may indicate that a variation of the response to the electromagnetic radiation may vary less than 50%, preferably less than 10%, over the complete spectral range from the UV to the FIR, i.e. from 100 nm to 1000 pm. Thus, in order to be able to provide a spectral sensitivity for a selected wavelength range, the detector may further comprise at least one optical band-pass filter which may, especially, adapted for this purpose.

Thus, the sensor region of the longitudinal optical sensor is illuminated by at the least one light beam. Given the same total power of the illumination, the electrical conductivity of the sensor region, therefore, depends on the beam cross-section of the light beam in the sensor region, be denominated as a “spot size” generated by the incident beam within the sensor region. Thus, the observable property that the longitudinal sensor signal depends on an extent of the illumination of the sensor region by an incident light beam particularly accomplishes that two light beams comprising the same total power but generating different spot sizes on the sensor region provide different values for the longitudinal sensor signal and are, consequently, distinguishable with respect to each other.

Further, since the longitudinal sensor signal is determined by applying an electrical signal, such as a voltage signal and/or a current signal, the electrical conductivity of the material which is traversed by the electrical signal is, therefore, taken into account when determining the longitudinal sensor signal. As will be explained below in more detail, an application of a bias voltage source and of a load resistor employed in series with the longitudinal optical sensor may preferably be used here. As a result, the longitudinal optical sensor, thus, principally allows determining the beam cross-section of the light beam in the sensor region from a recording of the longitudinal sensor signal, such as by comparing at least two longitudinal sensor signals, at least one item of information on the beam cross-section, specifically on the beam diameter.

Further, since the beam cross-section of the light beam in the sensor region, according to the above-mentioned FiP effect, given the same total power of the illumination, depends on the longitudinal position or depth of an object which emits or reflects the light beam which impinges on the sensor region, the longitudinal optical sensor may, therefore, be applied to determining a longitudinal position of the respective object.

As already known from WO 2012/110924 A1, the longitudinal optical sensor is designed to generate at least one longitudinal sensor signal in a manner dependent on an illumination of the sensor region, wherein the sensor signal, given the same total power of the illumination depends on a beam cross-section of the illumination on the sensor region. As an example, a measurement of a photocurrent I as a function of a position of a lens is provided there, wherein the lens is configured for focusing electromagnetic radiation onto the sensor region of the longitudinal optical sensor. During the measurement, the lens is displaced relative to the longitudinal optical sensor in a direction perpendicular to the sensor region in a manner that, as a result, the diameter of the light spot on the sensor region changes. In this particular example in which a photovoltaic device, in particular, a dye solar cell, is employed as the material in the sensor region, the signal of the longitudinal optical sensor, in this case a photocurrent, clearly depends on the geometry of the illumination such that, outside a maximum at the focus of the lens, the photocurrent falls to less than 10% of its maximum value.

As further used herein, the term “evaluation device” generally refers to an arbitrary device designed to generate the items of information, i.e. the at least one item of information on the position of the object. As an example, the evaluation device may be or may comprise one or more integrated circuits, such as one or more application-specific integrated circuits (ASICs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more filters. As used herein, the sensor signal may generally refer to one of the longitudinal sensor signal and, if applicable, to the transversal sensor signal. Further, the evaluation device may comprise one or more data storage devices. Further, as outlined above, the evaluation device may comprise one or more interfaces, such as one or more wireless interfaces and/or one or more wire-bound interfaces.

The at least one evaluation device may be adapted to perform at least one computer program, such as at least one computer program performing or supporting the step of generating the items of information. As an example, one or more algorithms may be implemented which, by using the sensor signals as input variables, may perform a predetermined transformation into the position of the object.

The evaluation device may particularly comprise at least one data processing device, in particular an electronic data processing device, which can be designed to generate the items of information by evaluating the sensor signals. Thus, the evaluation device is designed to use the sensor signals as input variables and to generate the items of information on the transversal position and the longitudinal position of the object by processing these input variables. The processing can be done in parallel, subsequently or even in a combined manner. The evaluation device may use an arbitrary process for generating these items of information, such as by calculation and/or using at least one stored and/or known relationship. Besides the sensor signals, one or a plurality of further parameters and/or items of information can influence said relationship, for example at least one item of information about a modulation frequency. The relationship can be determined or determinable empirically, analytically or else semi-empirically. Particularly preferably, the relationship comprises at least one calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the sensor signals into the items of information may be used. Alternatively, at least one combined relationship for processing the sensor signals is feasible. Various possibilities are conceivable and can also be combined.

By way of example, the evaluation device can be designed in terms of programming for the purpose of determining the items of information. The evaluation device can comprise in particular at least one computer, for example at least one microcomputer. Furthermore, the evaluation device can comprise one or a plurality of volatile or nonvolatile data memories. As an alternative or in addition to a data processing device, in particular at least one computer, the evaluation device can comprise one or a plurality of further electronic components which are designed for determining the items of information, for example an electronic table and in particular at least one look-up table and/or at least one application-specific integrated circuit (ASIC).

The detector has, as described above, at least one evaluation device. In particular, the at least one evaluation device can also be designed to completely or partly control or drive the detector, for example by the evaluation device being designed to control at least one illumination source and/or to control at least one modulation device of the detector. The evaluation device can be designed, in particular, to carry out at least one measurement cycle in which one or a plurality of sensor signals, such as a plurality of sensor signals, are picked up, for example a plurality of sensor signals of successively at different modulation frequencies of the illumination.

The evaluation device is designed, as described above, to generate at least one item of information on the position of the object by evaluating the at least one sensor signal. Said position of the object can be static or may even comprise at least one movement of the object, for example a relative movement between the detector or parts thereof and the object or parts thereof. In this case, a relative movement can generally comprise at least one linear movement and/or at least one rotational movement. Items of movement information can for example also be obtained by comparison of at least two items of information picked up at different times, such that for example at least one item of location information can also comprise at least one item of velocity information and/or at least one item of acceleration information, for example at least one item of information about at least one relative velocity between the object or parts thereof and the detector or parts thereof. In particular, the at least one item of location information can generally be selected from: an item of information about a distance between the object or parts thereof and the detector or parts thereof, in particular an optical path length; an item of information about a distance or an optical distance between the object or parts thereof and the optional transfer device or parts thereof; an item of information about a positioning of the object or parts thereof relative to the detector or parts thereof; an item of information about an orientation of the object and/or parts thereof relative to the detector or parts thereof; an item of information about a relative movement between the object or parts thereof and the detector or parts thereof; an item of information about a two-dimensional or three-dimensional spatial configuration of the object or of parts thereof, in particular a geometry or form of the object. Generally, the at least one item of location information can therefore be selected for example from the group consisting of: an item of information about at least one location of the object or at least one part thereof; information about at least one orientation of the object or a part thereof; an item of information about a geometry or form of the object or of a part thereof, an item of information about a velocity of the object or of a part thereof, an item of information about an acceleration of the object or of a part thereof, an item of information about a presence or absence of the object or of a part thereof in a visual range of the detector.

The at least one item of location information can be specified for example in at least one coordinate system, for example a coordinate system in which the detector or parts thereof rest. Alternatively or additionally, the location information can also simply comprise for example a distance between the detector or parts thereof and the object or parts thereof. Combinations of the possibilities mentioned are also conceivable.

In a particular embodiment of the present invention, the detector may comprise at least two longitudinal optical sensors, wherein each longitudinal optical sensor may be adapted to generate at least one longitudinal sensor signal. As an example, the sensor regions or the sensor surfaces of the longitudinal optical sensors may, thus, be oriented in parallel, wherein slight angular tolerances might be tolerable, such as angular tolerances of no more than 10°, preferably of no more than 5°. Herein, preferably all of the longitudinal optical sensors of the detector, which may, preferably, be arranged in form of a stack along the optical axis of the detector, may be transparent. Thus, the light beam may pass through a first transparent longitudinal optical sensor before impinging on the other longitudinal optical sensors, preferably subsequently. Thus, the light beam from the object may subsequently reach all longitudinal optical sensors present in the optical detector. Herein, the different longitudinal optical sensors may exhibit the same or different spectral sensitivities with respect to the incident light beam. Preferably, the detector according to the present invention may comprise a stack of longitudinal optical sensors as disclosed in WO 2014/097181 A1, particularly in combination with one or more transversal optical sensors. As an example, one or more transversal optical sensors may be located on a side of the stack of longitudinal optical sensors facing towards the object. Alternatively or additionally, one or more transversal optical sensors may be located on a side of the stack of longitudinal optical sensors facing away from the object. Again, additionally or alternatively, one or more transversal optical sensors may be interposed in between the longitudinal optical sensors of the stack. However, embodiments which may only comprise a single longitudinal optical sensor but no transversal optical sensor may still be possible, such as in a case wherein only determining the depth of the object may be desired.

As already defined above, the term “transversal optical sensor” generally refers to a device which is adapted to determine a transversal position of at least one light beam traveling from the object to the detector. With regard to the term position, reference may be made to the definition above. Thus, preferably, the transversal position may be or may comprise at least one coordinate in at least one dimension perpendicular to an optical axis of the detector. As an example, the transversal position may be a position of a light spot generated by the light beam in a plane perpendicular to the optical axis, such as on a light-sensitive sensor surface of the transversal optical sensor. As an example, the position in the plane may be given in Cartesian coordinates and/or polar coordinates. Other embodiments are feasible. For potential embodiments of the transversal optical sensor, reference may be made to WO 2014/097181 A1. However, other embodiments are feasible and will be outlined in further detail below.

The transversal optical sensor may provide at least one transversal sensor signal. Herein, the transversal sensor signal may generally be an arbitrary signal indicative of the transversal position. As an example, the transversal sensor signal may be or may comprise a digital and/or an analog signal. As an example, the transversal sensor signal may be or may comprise a voltage signal and/or a current signal. Additionally or alternatively, the transversal sensor signal may be or may comprise digital data. The transversal sensor signal may comprise a single signal value and/or a series of signal values. The transversal sensor signal may further comprise an arbitrary signal which may be derived by combining two or more individual signals, such as by averaging two or more signals and/or by forming a quotient of two or more signals.

In a first embodiment according to the disclosure of WO 2014/097181 A1, the transversal optical sensor may be a photo detector having at least one first electrode, at least one second electrode and at least one photovoltaic material, wherein the photovoltaic material may be embedded in between the first electrode and the second electrode. Thus, the transversal optical sensor may be or may comprise one or more photo detectors, such as one or more organic photodetectors and, most preferably, one or more dye-sensitized organic solar cells (DSCs, also referred to as dye solar cells), such as one or more solid dye-sensitized organic solar cells (s-DSCs). Thus, the detector may comprise one or more DSCs (such as one or more sDSCs) acting as the at least one transversal optical sensor and one or more DSCs (such as one or more sDSCs) acting as the at least one longitudinal optical sensor.

In a further embodiment as disclosed in WO 2016/120392 A1, the transversal optical sensor may comprise a layer of the photoconductive material, preferably an inorganic photoconductive material, in particular, lead sulfide (PbS), lead selenide (PbSe), lead telluride (PbTe), cadmium telluride (CdTe), indium phosphide (InP), cadmium sulfide (CdS), cadmium selenide (CdSe), indium antimonide (InSb), mercury cadmium telluride (HgCdTe; MCT), copper indium sulfide (CIS), copper indium gallium selenide (CIGS), zinc sulfide (ZnS), zinc selenide (ZnSe), copper zinc tin sulfide (CZTS), solid solutions and/or doped variants thereof. Preferably, the layer of the photoconductive material may be embedded in between two layers of a transparent conducting oxide, preferably comprising indium tin oxide (ITO), fluorine doped tin oxide (FTO), or magnesium oxide (MgO), wherein one of the two layers may be replaced by metal nanowires, in particular by Ag nanowires. However, other material may be feasible, in particular according to the desired transparent spectral range.

In a particularly preferred embodiment of the present invention, the transversal optical sensor may be or comprise at least one further thermoelectric unit, such as the thermoelectric units as described elsewhere in this document in more detail. As a result, the illumination of the further thermoelectric unit by an impinging light beam may, thus, cause at least one of a spatial variation or a temporal variation of the temperature in the further thermoelectric unit which may be further designed to generate the transversal sensor signal. Similarly as described above, the further thermoelectric unit may be or comprise a pyroelectric material, in particular a layer of the pyroelectric material. Herein, the layer of the pyroelectric material may constitute a continuous sensor area, wherein the at least one transversal sensor signal is an electrical sensor signal obtained for the entire sensor region. As described below in more detail, the transversal sensor signal may be evaluated, such as by using the evaluation device, in order to generate the at least one item of information on a transversal position of the object.

Further, at least two electrodes may be present for recording the transversal optical signal. In a preferred embodiment, the at least two electrodes may actually be arranged in the form of at least two physical electrodes, wherein each physical electrode may comprise an electrically conducting material, preferably a metallically conducting material, more preferred a highly metallically conducting material such as copper, silver, gold, an alloy or a composition which comprises these kinds of materials, or graphene. Herein, each of the at least two physical electrodes may, preferably, be arranged in a manner that a direct electrical contact between the respective electrode and the pyroelectric material, in particular the layer of the pyroelectric material, in the transversal optical sensor may be achieved, particularly in order to acquire the transversal sensor signal with as little loss as possible, such as due to additional resistances in a transport path between the optical sensor and the evaluation device.

Preferably, at least one of the electrodes of the transversal optical sensor may be a split electrode having at least two partial electrodes, preferably at least four partial electrodes, each of the partial electrodes preferably comprising a T shape, wherein the transversal optical sensor may have a sensor area, wherein the at least one transversal sensor signal may indicate an x-and/or a y-position of the incident light beam within the sensor area. The sensor area may be a surface of the photo detector facing towards the object. The sensor area preferably may be oriented perpendicular to the optical axis. Thus, the transversal sensor signal may indicate a position of a light spot generated by the light beam in a plane of the sensor area of the transversal optical sensor. Generally, as used herein, the term “partial electrode” refers to an electrode out of a plurality of electrodes, adapted for measuring at least one current and/or voltage signal, preferably independent from other partial electrodes. Thus, in case a plurality of partial electrodes is provided, the respective electrode is adapted to provide a plurality of electric potentials and/or electric currents and/or voltages via the at least two partial electrodes, which may be measured and/or used independently.

The transversal optical sensor may further be adapted to generate the transversal sensor signal in accordance with the electrical currents through the partial electrodes. Thus, a ratio of electric currents through two horizontal partial electrodes may be formed, thereby generating an x-coordinate, and/or a ratio of electric currents through to vertical partial electrodes may be formed, thereby generating a y-coordinate. The detector, preferably the transversal optical sensor and/or the evaluation device, may be adapted to derive the information on the transversal position of the object from at least one ratio of the currents through the partial electrodes. Other ways of generating position coordinates by comparing currents through the partial electrodes are feasible.

The partial electrodes may generally be defined in various ways, in order to determine a position of the light beam in the sensor area. Thus, two or more horizontal partial electrodes may be provided in order to determine a horizontal coordinate or x-coordinate, and two or more vertical partial electrodes may be provided in order to determine a vertical coordinate or y-coordinate. Thus, the partial electrodes may be provided at a rim of the sensor area, wherein an interior space of the sensor area remains free and may be covered by one or more additional electrode materials. As will be outlined in further detail below, the additional electrode material preferably may be a transparent additional electrode material, such as a transparent metal and/or a transparent conductive oxide and/or, most preferably, a transparent conductive polymer.

By using the transversal optical sensor, wherein one of the electrodes is a split electrode with two or more partial electrodes, currents through the partial electrodes may be dependent on a position of the light beam in the sensor area. This may generally be due to the fact that Ohmic losses or resistive losses may occur on the way from a location of generation of electrical charges due to the impinging light onto the partial electrodes. Thus, besides the partial electrodes, the split electrode may comprise one or more additional electrode materials connected to the partial electrodes, wherein the one or more additional electrode materials provide an electrical resistance. Thus, due to the Ohmic losses on the way from the location of generation of the electric charges to the partial electrodes through with the one or more additional electrode materials, the currents through the partial electrodes depend on the location of the generation of the electric charges and, thus, to the position of the light beam in the sensor area. For details of this principle of determining the position of the light beam in the sensor area, reference may be made to the preferred embodiments below and/or to the physical principles and device options as disclosed in WO 2014/097181 A1 and the respective references therein. Accordingly, the transversal optical sensor may comprise the sensor area, which, preferably, may be transparent to the light beam travelling from the object to the detector. The transversal optical sensor may, therefore, be adapted to determine a transversal position of the light beam in one or more transversal directions, such as in the x- and/or in the y-direction. For this purpose, the at least one transversal optical sensor may further be adapted to generate at least one transversal sensor signal. Thus, the evaluation device may be designed to generate at least one item of information on a transversal position of the object by evaluating the transversal sensor signal of the longitudinal optical sensor.

Further embodiments of the present invention referred to the nature of the light beam which propagates from the object to the detector. As used herein, the term “light” generally refers to electromagnetic radiation in one or more of the visible spectral range, the ultraviolet spectral range and the infrared spectral range. Therein, in partial accordance with standard ISO-21348 in a valid version at the date of this application, the term visible spectral range generally refers to a spectral range of 380 nm to 760 nm. The term infrared (IR) spectral range generally refers to electromagnetic radiation in the range of 760 nm to 1000 μm, wherein the range of 760 nm to 1.5 μm is usually denominated as the near infrared (NIR) spectral range, the range from 1.5 μm to 15 μm as the mid-infrared (mid-IR) spectral range, and the range from 15 μm to 1000 μm as the far infrared (FIR) spectral range. The term ultraviolet (UV) spectral range generally refers to electromagnetic radiation in the range of 1 nm to 380 nm, preferably in the range of 100 nm to 380 nm.

The term “light beam” generally refers to an amount of light emitted into a specific direction. Thus, the light beam may be a bundle of the light rays having a predetermined extension in a direction perpendicular to a direction of propagation of the light beam. Preferably, the light beam may be or may comprise one or more Gaussian light beams which may be characterized by one or more Gaussian beam parameters, such as one or more of a beam waist, a Rayleigh-length or any other beam parameter or combination of beam parameters suited to characterize a development of a beam diameter and/or a beam propagation in space.

The light beam might be admitted by the object itself, i.e. might originate from the object. Additionally or alternatively, another origin of the light beam is feasible. Thus, as will be outlined in further detail below, one or more illumination sources might be provided which illuminate the object, such as by using one or more primary rays or beams, such as one or more primary rays or beams having a predetermined characteristic. In the latter case, the light beam propagating from the object to the detector might be a light beam which is reflected by the object and/or a reflection device connected to the object.

As outlined above, the at least one longitudinal sensor signal, given the same total power of the illumination by the light beam, is, according to the FiP effect, dependent on a beam cross-section of the light beam in the sensor region of the at least one longitudinal optical sensor. As used herein, the term beam cross-section generally refers to a lateral extension of the light beam or a light spot generated by the light beam at a specific location. In case a circular light spot is generated, a radius, a diameter or a Gaussian beam waist or twice the Gaussian beam waist may function as a measure of the beam cross-section. In case non-circular light-spots are generated, the cross-section may be determined in any other feasible way, such as by determining the cross-section of a circle having the same area as the non-circular light spot, which is also referred to as the equivalent beam cross-section. Within this regard, it may be possible to employ the observation of an extremum, i.e. a maximum or a minimum, of the longitudinal sensor signal, in particular a global extremum, under a condition in which the corresponding material, such as a photovoltaic material, may be impinged by a light beam with the smallest possible cross-section, such as when the material may be located at or near a focal point as affected by an optical lens. In case the extremum is a maximum, this observation may be denominated as a “positive FiP-effect”, while in case the extremum is a minimum, this observation may be denominated as a “negative FiP-effect”.

Thus, irrespective of the thermoelectric unit actually comprised in the sensor region but given the same total power of the illumination of the sensor region by the light beam, a light beam having a first beam diameter or beam cross-section may generate a first longitudinal sensor signal, whereas a light beam having a second beam diameter or beam-cross section being different from the first beam diameter or beam cross-section generates a second longitudinal sensor signal being different from the first longitudinal sensor signal. Thus, by comparing the longitudinal sensor signals, at least one item of information on the beam cross-section, specifically on the beam diameter, may be generated. For details of this effect, reference may be made to WO 2012/110924 A1. Accordingly, the longitudinal sensor signals generated by the longitudinal optical sensors may be compared, in order to gain information on the total power and/or intensity of the light beam and/or in order to normalize the longitudinal sensor signals and/or the at least one item of information on the longitudinal position of the object for the total power and/or total intensity of the light beam. Thus, as an example, a maximum value of the longitudinal optical sensor signals may be detected, and all longitudinal sensor signals may be divided by this maximum value, thereby generating normalized longitudinal optical sensor signals, which, then, may be transformed by using the above-mentioned known relationship, into the at least one item of longitudinal information on the object. Other ways of normalization are feasible, such as a normalization using a mean value of the longitudinal sensor signals and dividing all longitudinal sensor signals by the mean value. Other options are possible. Each of these options may be appropriate to render the transformation independent from the total power and/or intensity of the light beam. In addition, information on the total power and/or intensity of the light beam might, thus, be generated.

Specifically in case one or more beam properties of the light beam propagating from the object to the detector are known, the at least one item of information on the longitudinal position of the object may thus be derived from a known relationship between the at least one longitudinal sensor signal and a longitudinal position of the object. The known relationship may be stored in the evaluation device as an algorithm and/or as one or more calibration curves. As an example, specifically for Gaussian beams, a relationship between a beam diameter or beam waist and a position of the object may easily be derived by using the Gaussian relationship between the beam waist and a longitudinal coordinate.

This embodiment may, particularly, be used by the evaluation device in order to resolve an ambiguity in the known relationship between a beam cross-section of the light beam and the longitudinal position of the object. Thus, even if the beam properties of the light beam propagating from the object to the detector are known fully or partially, it is known that, in many beams, the beam cross-section narrows before reaching a focal point and, afterwards, widens again. Thus, before and after the focal point in which the light beam has the narrowest beam cross-section, positions along the axis of propagation of the light beam occur in which the light beam has the same cross-section. Thus, as an example, at a distance z0 before and after the focal point, the cross-section of the light beam is identical. Thus, in case only one longitudinal optical sensor with a specific spectral sensitivity is used, a specific cross-section of the light beam might be determined, in case the overall power or intensity of the light beam is known. By using this information, the distance z0 of the respective longitudinal optical sensor from the focal point might be determined. However, in order to determine whether the respective longitudinal optical sensor is located before or behind the focal point, additional information is required, such as a history of movement of the object and/or the detector and/or information on whether the detector is located before or behind the focal point. In typical situations, this additional information may not be provided. Therefore, additional information may be gained in order to resolve the above-mentioned ambiguity. Thus, in case the evaluation device, by evaluating the longitudinal sensor signals, recognizes that the beam cross-section of the light beam on a first longitudinal optical sensor is larger than the beam cross-section of the light beam on a second longitudinal optical sensor, wherein the second longitudinal optical sensor is located behind the first longitudinal optical sensor, the evaluation device may determine that the light beam is still narrowing and that the location of the first longitudinal optical sensor is situated before the focal point of the light beam. Contrarily, in case the beam cross-section of the light beam on the first longitudinal optical sensor is smaller than the beam cross-section of the light beam on the second longitudinal optical sensor, the evaluation device may determine that the light beam is widening and that the location of the second longitudinal optical sensor is situated behind the focal point. Thus, generally, the evaluation device may be adapted to recognize whether the light beam widens or narrows, by comparing the longitudinal sensor signals of different longitudinal sensors.

For further details with regard to determining the at least one item of information on the longitudinal position of the object by employing the evaluation device according to the present invention, reference may made to the description in WO 2014/097181 A1. Thus, generally, the evaluation device may be adapted to compare the beam cross-section and/or the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

As already mentioned above, in addition to the at least one longitudinal coordinate of the object, at least one transversal coordinate of the object may be determined. Thus, generally, the evaluation device may further be adapted to determine at least one transversal coordinate of the object by determining a position of the light beam on the at least one transversal optical sensor, which may be a pixelated, a segmented or a large-area transversal optical sensor, as further outlined also in WO 2014/097181 A1.

In addition, the detector may comprise at least one transfer device, such as an optical lens, in particular one or more refractive lenses, particularly converging thin refractive lenses, such as convex or biconvex thin lenses, and/or one or more convex mirrors, which may further be arranged along the common optical axis. Most preferably, the light beam which emerges from the object may in this case travel first through the at least one transfer device and thereafter through the single transparent longitudinal optical sensor or the stack of the transparent longitudinal optical sensors until it may finally impinge on an imaging device. As used herein, the term “transfer device” refers to an optical element which may be configured to transfer the at least one light beam emerging from the object to optical sensors within the detector, i.e. the at least one longitudinal optical sensor and the at least one optional transversal optical sensor. Thus, the transfer device can be designed to feed light propagating from the object to the detector to the optical sensors, wherein this feeding can optionally be effected by means of imaging or else by means of non-imaging properties of the transfer device. In particular the transfer device can also be designed to collect the electromagnetic radiation before the latter is fed to the transversal and/or longitudinal optical sensor.

In addition, the at least one transfer device may have imaging properties. Consequently, the transfer device comprises at least one imaging element, for example at least one lens and/or at least one curved mirror, since, in the case of such imaging elements, for example, a geometry of the illumination on the sensor region can be dependent on a relative positioning, for example a distance, between the transfer device and the object. As used herein, the transfer device may be designed in such a way that the electromagnetic radiation which emerges from the object is transferred completely to the sensor region, for example is focused completely onto the sensor region, in particular if the object is arranged in a visual range of the detector.

Generally, the detector may further comprise at least one imaging device, i.e. a device capable of acquiring at least one image. The imaging device can be embodied in various ways. Thus, the imaging device can be for example part of the detector in a detector housing. Alternatively or additionally, however, the imaging device can also be arranged outside the detector housing, for example as a separate imaging device. Alternatively or additionally, the imaging device can also be connected to the detector or even be part of the detector. In a preferred arrangement, the stack of the transparent longitudinal optical sensors and the imaging device are aligned along a common optical axis along which the light beam travels. Thus, it may be possible to locate an imaging device in the optical path of the light beam in a manner that the light beam travels through the stack of the transparent longitudinal optical sensors until it impinges on the imaging device. However, other arrangements are possible.

As used herein, an “imaging device” is generally understood as a device which can generate a one-dimensional, a two-dimensional, or a three-dimensional image of the object or of a part thereof. In particular, the detector, with or without the at least one optional imaging device, can be completely or partly used as a camera, such as an IR camera, or an RGB camera, i.e. a camera which is designed to deliver three basic colors which are designated as red, green, and blue, on three separate connections. Typically, the imaging device constitutes an intransparent device, thus, usually being in contrast to a, preferably, transparent transversal optical sensor. Thus, as an example, the at least one imaging device may be or may comprise at least one imaging device selected from the group consisting of: a pixelated organic camera element, preferably a pixelated organic camera chip; a pixelated inorganic camera element, preferably a pixelated inorganic camera chip, more preferably a CCD- or CMOS-chip; a monochrome camera element, preferably a monochrome camera chip; a multicolor camera element, preferably a multicolor camera chip; a full-color camera element, preferably a full-color camera chip. The imaging device may be or may comprise at least one device selected from the group consisting of a monochrome imaging device, a multi-chrome imaging device and at least one full color imaging device. A multi-chrome imaging device and/or a full color imaging device may be generated by using filter techniques and/or by using intrinsic color sensitivity or other techniques, as the skilled person will recognize. Other embodiments of the imaging device are also possible.

The imaging device may be designed to image a plurality of partial regions of the object successively and/or simultaneously. By way of example, a partial region of the object can be a one-dimensional, a two-dimensional, or a three-dimensional region of the object which is delimited for example by a resolution limit of the imaging device and from which electromagnetic radiation emerges. In this context, imaging should be understood to mean that the electromagnetic radiation which emerges from the respective partial region of the object is fed into the imaging device, for example by means of the at least one optional transfer device of the detector. The electromagnetic rays can be generated by the object itself, for example in the form of a luminescent radiation. Alternatively or additionally, the at least one detector may comprise at least one illumination source for illuminating the object.

In particular, the imaging device can be designed to image sequentially, for example by means of a scanning method, in particular using at least one row scan and/or line scan, the plurality of partial regions sequentially. However, other embodiments are also possible, for example embodiments in which a plurality of partial regions is simultaneously imaged. The imaging device is designed to generate, during this imaging of the partial regions of the object, signals, preferably, electronic signals, associated with the partial regions. The signal may be an analogue and/or a digital signal. By way of example, an electronic signal can be associated with each partial region. The electronic signals can accordingly be generated simultaneously or else in a temporally staggered manner. By way of example, during a row scan or line scan, it is possible to generate a sequence of electronic signals which correspond to the partial regions of the object, which are strung together in a line, for example. Further, the imaging device may comprise one or more signal processing devices, such as one or more filters and/or analogue-digital-converters for processing and/or preprocessing the electronic signals.

Light emerging from the object can originate in the object itself, but can also optionally have a different origin and propagate from this origin to the object and subsequently toward the optical sensors. The latter case can be affected for example by at least one illumination source being used. The illumination source can be embodied in various ways. Thus, the illumination source can be for example part of the detector in a detector housing. Alternatively or additionally, however, the at least one illumination source can also be arranged outside a detector housing, for example as a separate light source. The illumination source can be arranged separately from the object and illuminate the object from a distance. Alternatively or additionally, the illumination source can also be connected to the object or even be part of the object, such that, by way of example, the electromagnetic radiation emerging from the object can also be generated directly by the illumination source. By way of example, at least one illumination source can be arranged on and/or in the object and directly generate the electromagnetic radiation by means of which the sensor region is illuminated. This illumination source can for example be or comprise an ambient light source and/or may be or may comprise an artificial illumination source. By way of example, at least one infrared emitter and/or at least one emitter for visible light and/or at least one emitter for ultraviolet light can be arranged on the object. By way of example, at least one light emitting diode and/or at least one laser diode can be arranged on and/or in the object. The illumination source can comprise in particular one or a plurality of the following illumination sources: a laser, in particular a laser diode, although in principle, alternatively or additionally, other types of lasers can also be used; a light emitting diode; an incandescent lamp; a neon light; a flame source; a heat source; an organic light source, in particular an organic light emitting diode; a structured light source. Alternatively or additionally, other illumination sources can also be used. It is particularly preferred if the illumination source is designed to generate one or more light beams having a Gaussian beam profile, as is at least approximately the case for example in many lasers. For further potential embodiments of the optional illumination source, reference may be made to one of WO 2012/110924 A1 and WO 2014/097181 A1. Still, other embodiments are feasible.

The at least one optional illumination source generally may emit light in at least one of: the ultraviolet (UV) spectral range, preferably in the range of 200 nm to 380 nm; the visible spectral range, i.e. in the range of 380 nm to 780 nm; the near-infrared (NIR) spectral range, preferably in the range of 780 nm to 1.5 μm; the mid-infrared (mid-IR) spectral range, preferably in the range of 1.5 μm to 15 μm; and the far infrared (FIR) spectral range, preferably in the range of 15 μm to 1000 μm. Herein, it is particularly preferred when the illumination source may exhibit a spectral range which may be related to the spectral sensitivities of the optical sensors, particularly in a manner to ensure that the optical sensor which may be illuminated by the respective illumination source may provide a sensor signal with a high intensity which may, thus, enable a high-resolution evaluation with a sufficient signal-to-noise-ratio.

Furthermore, the detector can have at least one modulation device for modulating the illumination, in particular for a periodic modulation, in particular a periodic beam interrupting device. A modulation of the illumination should be understood to mean a process in which a total power of the illumination is varied, preferably periodically, in particular with one or a plurality of modulation frequencies. In particular, a periodic modulation can be effected between a maximum value and a minimum value of the total power of the illumination. The minimum value can be 0, but can also be >0, such that, by way of example, complete modulation does not have to be effected. The modulation can be effected for example in a beam path between the object and the optical sensor, for example by the at least one modulation device being arranged in said beam path. Alternatively or additionally, however, the modulation can also be effected in a beam path between an optional illumination source—described in even greater detail below—for illuminating the object and the object, for example by the at least one modulation device being arranged in said beam path. A combination of these possibilities is also conceivable. The at least one modulation device can comprise for example a beam chopper or some other type of periodic beam interrupting device, for example comprising at least one interrupter blade or interrupter wheel, which preferably rotates at constant speed and which can thus periodically interrupt the illumination. Alternatively or additionally, however, it is also possible to use one or a plurality of different types of modulation devices, for example modulation devices based on an electro-optical effect and/or an acousto-optical effect. Once again alternatively or additionally, the at least one optional illumination source itself can also be designed to generate a modulated illumination, for example by said illumination source itself having a modulated intensity and/or total power, for example a periodically modulated total power, and/or by said illumination source being embodied as a pulsed illumination source, for example as a pulsed laser. Thus, by way of example, the at least one modulation device can also be wholly or partly integrated into the illumination source. Various possibilities are conceivable.

Accordingly, the detector can be designed in particular to detect at least two longitudinal sensor signals in the case of different modulations, in particular at least two longitudinal sensor signals at respectively different modulation frequencies. The evaluation device can be designed to generate the geometrical information from the at least two longitudinal sensor signals. As described in WO 2012/110924 A1 and WO 2014/097181 A1, it is possible to resolve ambiguities and/or it is possible to take account of the fact that, for example, a total power of the illumination is generally unknown. By way of example, the detector can be designed to bring about a modulation of the illumination of the object and/or at least one sensor region of the detector, such as at least one sensor region of the at least one longitudinal optical sensor, with a frequency of 0.05 Hz to 1 MHz, such as 0.1 Hz to 10 kHz. As outlined above, for this purpose, the detector may comprise at least one modulation device, which may be integrated into the at least one optional illumination source and/or may be independent from the illumination source. Thus, at least one illumination source might, by itself, be adapted to generate the above-mentioned modulation of the illumination, and/or at least one independent modulation device may be present, such as at least one chopper and/or at least one device having a modulated transmissibility, such as at least one electro-optical device and/or at least one acousto-optical device.

According to the present invention, it may be advantageous in order to apply at least one modulation frequency to the optical detector as described above. However, it may still be possible to directly determine the longitudinal sensor signal without applying a modulation frequency to the optical detector. As will be demonstrated below in more detail, an application of a modulation frequency may not be required under many relevant circumstances in order to acquire the desired longitudinal information about the object. As a result, the optical detector may, thus, not be required to comprise a modulation device which may further contribute to the simple and cost-effective setup of the spatial detector. As a further result, a spatial light modulator may be used in a time-multiplexing mode rather than a frequency-multiplexing mode or in a combination thereof.

In a further aspect of the present invention, an arrangement comprising at least two individual detectors according to any of the preceding embodiments, preferably two or three individual optical sensors, which may be placed at two distinct locations is proposed. Herein, the at least two detectors preferably may have identical optical properties but might also be different with respect from each other. In addition, the arrangement may further comprise at least one illumination source. Herein, the at least one object might be illuminated by using at least one illumination source which generates primary light, wherein the at least one object elastically or inelastically reflects the primary light, thereby generating a plurality of light beams which propagate to one of the at least two detectors. The at least one illumination source may form or may not form a constituent part of each of the at least two detectors. By way of example, the at least one illumination source itself may be or may comprise an ambient light source and/or may be or may comprise an artificial illumination source. This embodiment is preferably suited for an application in which at least two detectors, preferentially two identical detectors, are employed for acquiring depth information, in particular, for the purpose to providing a measurement volume which extends the inherent measurement volume of a single detector.

In this regard, the individual optical sensor may, preferably, be spaced apart from the other individual optical sensors comprised by the detector in order to allow acquiring an individual image which may differ from the images taken by the other individual optical sensors. In particular, the individual optical sensors may be arranged in separate beam paths in a collimated arrangement in order to generate a single circular, three-dimensional image. Thus, the individual optical sensors may be aligned in a manner that they are located parallel to the optical axis and may, in addition, exhibit an individual displacement in an orientation perpendicular to the optical axis of the detector. Herein, an alignment may be achieved by adequate measures, such as by adjusting a location and orientation of the individual optical sensor and/or the corresponding transfer element. Thus, the two individual optical sensors may, preferably, be spaced apart in a manner that they may be able to generate or increase a perception of depth information, especially in a fashion that the depth information may be obtained by combining visual information as derived from the two individual optical sensors having overlapping fields of view, such as the visual information as obtained by binocular vision. For this purpose, the individual optical sensors may, preferably be spaced apart from each other by a distance from 1 cm to 100 cm, preferably from 10 cm to 25 cm, as determined in the direction perpendicular to the optical axis. As used herein, the detector as provided in this embodiment may, in particular, be part of a “stereoscopic system” which will be described below in more detail. Besides allowing stereoscopic vision, further particular advantages of the stereoscopic system which are primarily based on a use of more than one optical sensor may, in particular, include an increase of the total intensity and/or a lower detection threshold.

In a further aspect of the present invention, a human-machine interface for exchanging at least one item of information between a user and a machine is proposed. The human-machine interface as proposed may make use of the fact that the above-mentioned detector in one or more of the embodiments mentioned above or as mentioned in further detail below may be used by one or more users for providing information and/or commands to a machine. Thus, preferably, the human-machine interface may be used for inputting control commands.

The human-machine interface comprises at least one detector according to the present invention, such as according to one or more of the embodiments disclosed above and/or according to one or more of the embodiments as disclosed in further detail below, wherein the human-machine interface is designed to generate at least one item of geometrical information of the user by means of the detector wherein the human-machine interface is designed to assign the geometrical information to at least one item of information, in particular to at least one control command.

In a further aspect of the present invention, an entertainment device for carrying out at least one entertainment function is disclosed. As used herein, an entertainment device is a device which may serve the purpose of leisure and/or entertainment of one or more users, in the following also referred to as one or more players. As an example, the entertainment device may serve the purpose of gaming, preferably computer gaming. Additionally or alternatively, the entertainment device may also be used for other purposes, such as for exercising, sports, physical therapy or motion tracking in general. Thus, the entertainment device may be implemented into a computer, a computer network or a computer system or may comprise a computer, a computer network or a computer system which runs one or more gaming software programs.

The entertainment device comprises at least one human-machine interface according to the present invention, such as according to one or more of the embodiments disclosed above and/or according to one or more of the embodiments disclosed below. The entertainment device is designed to enable at least one item of information to be input by a player by means of the human-machine interface. The at least one item of information may be transmitted to and/or may be used by a controller and/or a computer of the entertainment device.

In a further aspect of the present invention, a tracking system for tracking the position of at least one movable object is provided. As used herein, a tracking system is a device which is adapted to gather information on a series of past positions of the at least one object or at least one part of an object. Additionally, the tracking system may be adapted to provide information on at least one predicted future position of the at least one object or the at least one part of the object. The tracking system may have at least one track controller, which may fully or partially be embodied as an electronic device, preferably as at least one data processing device, more preferably as at least one computer or microcontroller. Again, the at least one track controller may comprise the at least one evaluation device and/or may be part of the at least one evaluation device and/or might fully or partially be identical to the at least one evaluation device.

The tracking system comprises at least one detector according to the present invention, such as at least one detector as disclosed in one or more of the embodiments listed above and/or as disclosed in one or more of the embodiments below. The tracking system further comprises at least one track controller. The tracking system may comprise one, two or more detectors, particularly two or more identical detectors, which allow for a reliable acquisition of depth information about the at least one object in an overlapping volume between the two or more detectors. The track controller is adapted to track a series of positions of the object, each position comprising at least one item of information on a position of the object at a specific point in time.

The tracking system may further comprise at least one beacon device connectable to the object. For a potential definition of the beacon device, reference may be made to WO 2014/097181 A1. The tracking system preferably is adapted such that the detector may generate an information on the position of the object of the at least one beacon device, in particular to generate the information on the position of the object which comprises a specific beacon device exhibiting a specific spectral sensitivity. Thus, more than one beacon exhibiting a different spectral sensitivity may be tracked by the detector of the present invention, preferably in a simultaneous manner. Herein, the beacon device may fully or partially be embodied as an active beacon device and/or as a passive beacon device. As an example, the beacon device may comprise at least one illumination source adapted to generate at least one light beam to be transmitted to the detector. Additionally or alternatively, the beacon device may comprise at least one reflector adapted to reflect light generated by an illumination source, thereby generating a reflected light beam to be transmitted to the detector.

In a further aspect of the present invention, a scanning system for determining at least one position of at least one object is provided. As used herein, the scanning system is a device which is adapted to emit at least one light beam being configured for an illumination of at least one dot located at at least one surface of the at least one object and for generating at least one item of information about the distance between the at least one dot and the scanning system. For the purpose of generating the at least one item of information about the distance between the at least one dot and the scanning system, the scanning system comprises at least one of the detectors according to the present invention, such as at least one of the detectors as disclosed in one or more of the embodiments listed above and/or as disclosed in one or more of the embodiments below.

Thus, the scanning system comprises at least one illumination source which is adapted to emit the at least one light beam being configured for the illumination of the at least one dot located at the at least one surface of the at least one object. As used herein, the term “dot” refers to a small area on a part of the surface of the object which may be selected, for example by a user of the scanning system, to be illuminated by the illumination source. Preferably, the dot may exhibit a size which may, on one hand, be as small as possible in order to allow the scanning system determining a value for the distance between the illumination source comprised by the scanning system and the part of the surface of the object on which the dot may be located as exactly as possible and which, on the other hand, may be as large as possible in order to allow the user of the scanning system or the scanning system itself, in particular by an automatic procedure, to detect a presence of the dot on the related part of the surface of the object.

For this purpose, the illumination source may comprise an artificial illumination source, in particular at least one laser source and/or at least one incandescent lamp and/or at least one semiconductor light source, for example, at least one light-emitting diode, in particular an organic and/or inorganic light-emitting diode. On account of their generally defined beam profiles and other properties of handleability, the use of at least one laser source as the illumination source is particularly preferred. Herein, the use of a single laser source may be preferred, in particular in a case in which it may be important to provide a compact scanning system that might be easily storable and transportable by the user. The illumination source may thus, preferably be a constituent part of the detector and may, therefore, in particular be integrated into the detector, such as into the housing of the detector. In a preferred embodiment, particularly the housing of the scanning system may comprise at least one display configured for providing distance-related information to the user, such as in an easy-to-read manner. In a further preferred embodiment, particularly the housing of the scanning system may, in addition, comprise at least one button which may be configured for operating at least one function related to the scanning system, such as for setting one or more operation modes. In a further preferred embodiment, particularly the housing of the scanning system may, in addition, comprise at least one fastening unit which may be configured for fastening the scanning system to a further surface, such as a rubber foot, a base plate or a wall holder, such comprising as magnetic material, in particular for increasing the accuracy of the distance measurement and/or the handleablity of the scanning system by the user.

In a particularly preferred embodiment, the illumination source of the scanning system may, thus, emit a single laser beam which may be configured for the illumination of a single dot located at the surface of the object. By using at least one of the detectors according to the present invention at least one item of information about the distance between the at least one dot and the scanning system may, thus, be generated. Hereby, preferably, the distance between the illumination system as comprised by the scanning system and the single dot as generated by the illumination source may be determined, such as by employing the evaluation device as comprised by the at least one detector. However, the scanning system may, further, comprise an additional evaluation system which may, particularly, be adapted for this purpose. Alternatively or in addition, a size of the scanning system, in particular of the housing of the scanning system, may be taken into account and, thus, the distance between a specific point on the housing of the scanning system, such as a front edge or a back edge of the housing, and the single dot may, alternatively, be determined.

Alternatively, the illumination source of the scanning system may emit two individual laser beams which may be configured for providing a respective angle, such as a right angle, between the directions of an emission of the beams, whereby two respective dots located at the surface of the same object or at two different surfaces at two separate objects may be illuminated. However, other values for the respective angle between the two individual laser beams may also be feasible. This feature may, in particular, be employed for indirect measuring functions, such as for deriving an indirect distance which may not be directly accessible, such as due to a presence of one or more obstacles between the scanning system and the dot or which may otherwise be hard to reach. By way of example, it may, thus, be feasible to determine a value for a height of an object by measuring two individual distances and deriving the height by using the Pythagoras formula. In particular for being able to keep a predefined level with respect to the object, the scanning system may, further, comprise at least one leveling unit, in particular an integrated bubble vial, which may be used for keeping the predefined level by the user.

As a further alternative, the illumination source of the scanning system may emit a plurality of individual laser beams, such as an array of laser beams which may exhibit a respective pitch, in particular a regular pitch, with respect to each other and which may be arranged in a manner in order to generate an array of dots located on the at least one surface of the at least one object. For this purpose, specially adapted optical elements, such as beam-splitting devices and mirrors, may be provided which may allow a generation of the described array of the laser beams.

Thus, the scanning system may provide a static arrangement of the one or more dots placed on the one or more surfaces of the one or more objects. Alternatively, illumination source of the scanning system, in particular the one or more laser beams, such as the above described array of the laser beams, may be configured for providing one or more light beams which may exhibit a varying intensity over time and/or which may be subject to an alternating direction of emission in a passage of time. Thus, the illumination source may be configured for scanning a part of the at least one surface of the at least one object as an image by using one or more light beams with alternating features as generated by the at least one illumination source of the scanning device. In particular, the scanning system may, thus, use at least one row scan and/or line scan, such as to scan the one or more surfaces of the one or more objects sequentially or simultaneously.

In a further aspect of the present invention, a stereoscopic system for generating at least one single circular, three-dimensional image of at least one object is provided. As used herein, the stereoscopic system as disclosed above and/or below may comprise at least two of the FiP sensors as the optical sensors, wherein a first FiP sensor may be comprised in a tracking system, in particular in a tracking system according to the present invention, while a second FiP sensor may be comprised in a scanning system, in particular in a scanning system according to the present invention. Herein, the FiP sensors may, preferably, be arranged in separate beam paths in a collimated arrangement, such as by aligning the FiP sensors parallel to the optical axis and individually displaced perpendicular to the optical axis of the stereoscopic system. Thus, the FiP sensors may be able to generate or increase a perception of depth information, especially, by obtaining the depth information by a combination of the visual information derived from the individual FiP sensors which have overlapping fields of view and are, preferably, sensitive to an individual modulation frequency. For this purpose, the individual FiP sensors may, preferably, be spaced apart from each other by a distance from 1 cm to 100 cm, preferably from 10 cm to 25 cm, as determined in the direction perpendicular to the optical axis. In this preferred embodiment, the tracking system may, thus, be employed for determining a position of a modulated active target while the scanning system which is adapted to project one or more dots onto the one or more surfaces of the one or more objects may be used for generating at least one item of information about the distance between the at least one dot and the scanning system. In addition, the stereoscopic system may further comprise a separate position sensitive device being adapted for generating the item of information on the transversal position of the at least one object within the image as described elsewhere in this application.

Besides allowing stereoscopic vision, further particular advantages of the stereoscopic system which are primarily based on a use of more than one optical sensor may, in particular, include an increase of the total intensity and/or a lower detection threshold. Further, whereas in a conventional stereoscopic system which comprises at least two conventional position sensitive devices corresponding pixels in the respective images have to be determined by applying considerable computational effort, in the stereoscopic system according to the present invention which comprises at least two FiP sensors the corresponding pixels in the respective images being recorded by using the FiP sensors, wherein each of the FiP sensors may be operated with a different modulation frequency, may apparently be assigned with respect to each other. Thus, it may be emphasized that the stereoscopic system according to the present invention may allow generating the at least one item of information on the longitudinal position of the object as well as on the transversal position of the object with reduced effort.

For further details of the stereoscopic system, reference may be made to the description of the tracking system and the scanning system, respectively.

In a further aspect of the present invention, a camera for imaging at least one object is disclosed. The camera comprises at least one detector according to the present invention, such as disclosed in one or more of the embodiments given above or given in further detail below. Thus, the detector may be part of a photographic device, specifically of a digital camera. Specifically, the detector may be used for 3D photography, specifically for digital 3D photography. Thus, the detector may form a digital 3D camera or may be part of a digital 3D camera. As used herein, the term “photography” generally refers to the technology of acquiring image information of at least one object. As further used herein, a “camera” generally is a device adapted for performing photography. As further used herein, the term “digital photography” generally refers to the technology of acquiring image information of at least one object by using a plurality of light-sensitive elements adapted to generate electrical signals indicating an intensity of illumination, preferably digital electrical signals. As further used herein, the term “3D photography” generally refers to the technology of acquiring image information of at least one object in three spatial dimensions. Accordingly, a 3D camera is a device adapted for performing 3D photography. The camera generally may be adapted for acquiring a single image, such as a single 3D image, or may be adapted for acquiring a plurality of images, such as a sequence of images. Thus, the camera may also be a video camera adapted for video applications, such as for acquiring digital video sequences.

Thus, generally, the present invention further refers to a camera, specifically a digital camera, more specifically a 3D camera or digital 3D camera, for imaging at least one object. As outlined above, the term imaging, as used herein, generally refers to acquiring image information of at least one object. The camera comprises at least one detector according to the present invention. The camera, as outlined above, may be adapted for acquiring a single image or for acquiring a plurality of images, such as image sequence, preferably for acquiring digital video sequences. Thus, as an example, the camera may be or may comprise a video camera. In the latter case, the camera preferably comprises a data memory for storing the image sequence.

In a further aspect of the present invention, a method for determining a position of at least one object is disclosed. The method preferably may make use of at least one detector according to the present invention, such as of at least one detector according to one or more of the embodiments disclosed above or disclosed in further detail below. Thus, for optional embodiments of the method, reference might be made to the description of the various embodiments of the detector.

The method comprises the following steps, which may be performed in the given order or in a different order. Further, additional method steps might be provided which are not listed. Further, two or more or even all of the method steps might be performed simultaneously, at least partially. Further, two or more or even all of the method steps might be performed twice or even more than twice, repeatedly.

The method according to the present invention comprises the following steps:
generating at least one longitudinal sensor signal by using at least one longitudinal optical sensor, wherein the longitudinal optical sensor has at least one sensor region, wherein the at least one longitudinal sensor signal is generated in a manner dependent on an illumination of the sensor region by a light beam, wherein the longitudinal sensor signal, given the same total power of the illumination, is dependent on a beam cross-section of the light beam in the sensor region, wherein the sensor region is or comprises at least one thermoelectric unit, wherein, upon illumination of the sensor region or a partition thereof by the light beam, at least one of a spatial variation or a temporal variation of the temperature in the thermoelectric unit is designed to generate the longitudinal sensor signal; and
generating at least one item of information on a longitudinal position of the object by evaluating the longitudinal sensor signal.

For further details concerning the method according to the present invention, reference may be made to the description of the optical detector as provided above and/or below.

In a further aspect of the present invention, a use of a detector according to the present invention is disclosed. Therein, a use of the detector for a purpose of determining a position of an object, in particular a lateral position of an object, is proposed, wherein the detector may, preferably, be used concurrently as at least one longitudinal optical sensor or combined with at least one additional longitudinal optical sensor, in particular, for a purpose of use selected from the group consisting of: a position measurement, in particular in traffic technology; an entertainment application; a security application; a human-machine interface application; a tracking application; a scanning application; a stereoscopic vision application; a photography application; an imaging application or camera application; a mapping application for generating maps of at least one space; a homing or tracking beacon detector for vehicles; a position measurement of objects with a thermal signature (hotter or colder than background); a machine vision application; a robotic application.

Thus, generally, the devices according to the present invention, such as the detector, may be applied in various fields of uses. Specifically, the detector may be applied for a purpose of use, selected from the group consisting of: a position measurement in traffic technology; an entertainment application; a security application; a human-machine interface application; a tracking application; a photography application; a cartography application; a mapping application for generating maps of at least one space; a homing or tracking beacon detector for vehicles; a mobile application; a webcam; an audio device; a Dolby surround audio system; a computer peripheral device; a gaming application; a camera or video application; a surveillance application; an automotive application; a transport application; a logistics application; a vehicle application; an airplane application; a ship application; a spacecraft application; a robotic application; a medical application; a sports' application; a building application; a construction application; a manufacturing application; a machine vision application; a use in combination with at least one sensing technology selected from time-of-flight detector, radar, Lidar, ultrasonic sensors, or interferometry. Additionally or alternatively, applications in local and/or global positioning systems may be named, especially landmark-based positioning and/or navigation, specifically for use in cars or other vehicles (such as trains, motorcycles, bicycles, trucks for cargo transportation), robots or for use by pedestrians. Further, indoor positioning systems may be named as potential applications, such as for household applications and/or for robots used in manufacturing, logistics, surveillance, or maintenance technology.

Thus, firstly, the devices according to the present invention may be used in mobile phones, tablet computers, laptops, smart panels or other stationary or mobile or wearable computer or communication applications. Thus, the devices according to the present invention may be combined with at least one active light source, such as a light source emitting light in the visible range or infrared spectral range, in order to enhance performance. Thus, as an example, the devices according to the present invention may be used as cameras and/or sensors, such as in combination with mobile software for scanning and/or detecting environment, objects and living beings. The devices according to the present invention may even be combined with 2D cameras, such as conventional cameras, in order to increase imaging effects. The devices according to the present invention may further be used for surveillance and/or for recording purposes or as input devices to control mobile devices, especially in combination with voice and/or gesture recognition. Thus, specifically, the devices according to the present invention acting as human-machine interfaces, also referred to as input devices, may be used in mobile applications, such as for controlling other electronic devices or components via the mobile device, such as the mobile phone. As an example, the mobile application including at least one device according to the present invention may be used for controlling a television set, a game console, a music player or music device or other entertainment devices.

Further, the devices according to the present invention may be used in webcams or other peripheral devices for computing applications. Thus, as an example, the devices according to the present invention may be used in combination with software for imaging, recording, surveillance, scanning, or motion detection. As outlined in the context of the human-machine interface and/or the entertainment device, the devices according to the present invention are particularly useful for giving commands by facial expressions and/or body expressions. The devices according to the present invention can be combined with other input generating devices like e.g. mouse, keyboard, touchpad, microphone etc. Further, the devices according to the present invention may be used in applications for gaming, such as by using a webcam. Further, the devices according to the present invention may be used in virtual training applications and/or video conferences. Further, devices according to the present invention may be used to recognize or track hands, arms, or objects used in a virtual or augmented reality application, especially when wearing head mounted displays.

Further, the devices according to the present invention may be used in mobile audio devices, television devices and gaming devices, as partially explained above. Specifically, the devices according to the present invention may be used as controls or control devices for electronic devices, entertainment devices or the like. Further, the devices according to the present invention may be used for eye detection or eye tracking, such as in 2D- and 3D-display techniques, especially with transparent displays for augmented reality applications and/or for recognizing whether a display is being looked at and/or from which perspective a display is being looked at. Further, devices according to the present invention may be used to explore a room, boundaries, obstacles, in connection with a virtual or augmented reality application, especially when wearing a head-mounted display.

Further, the devices according to the present invention may be used in or as digital cameras such as DSC cameras and/or in or as reflex cameras such as SLR cameras. For these applications, reference may be made to the use of the devices according to the present invention in mobile applications such as mobile phones, as disclosed above.

Further, the devices according to the present invention may be used for security or surveillance applications. Thus, as an example, at least one device according to the present invention can be combined with one or more digital and/or analogue electronics that will give a signal if an object is within or outside a predetermined area (e.g. for surveillance applications in banks or museums). Specifically, the devices according to the present invention may be used for optical encryption. Detection by using at least one device according to the present invention can be combined with other detection devices to complement wavelengths, such as with IR, x-ray, UV-VIS, radar or ultrasound detectors. The devices according to the present invention may further be combined with an active infrared light source to allow detection in low light surroundings. The devices according to the present invention are generally advantageous as compared to active detector systems, specifically since the devices according to the present invention avoid actively sending signals which may be detected by third parties, as is the case e.g. in radar applications, ultrasound applications, LIDAR or similar active detector devices. Thus, generally, the devices according to the present invention may be used for an unrecognized and undetectable tracking of moving objects. Additionally, the devices according to the present invention generally are less prone to manipulations and irritations as compared to conventional devices.

Further, given the ease and accuracy of 3D detection by using the devices according to the present invention, the devices according to the present invention generally may be used for facial, body and person recognition and identification. Therein, the devices according to the present invention may be combined with other detection means for identification or personalization purposes such as passwords, finger prints, iris detection, voice recognition or other means. Thus, generally, the devices according to the present invention may be used in security devices and other personalized applications.

Further, the devices according to the present invention may be used as 3D barcode readers for product identification.

In addition to the security and surveillance applications mentioned above, the devices according to the present invention generally can be used for surveillance and monitoring of spaces and areas. Thus, the devices according to the present invention may be used for surveying and monitoring spaces and areas and, as an example, for triggering or executing alarms in case prohibited areas are violated. Thus, generally, the devices according to the present invention may be used for surveillance purposes in building surveillance or museums, optionally in combination with other types of sensors, such as in combination with motion or heat sensors, in combination with image intensifiers or image enhancement devices and/or photomultipliers. Further, the devices according to the present invention may be used in public spaces or crowded spaces to detect potentially hazardous activities such as commitment of crimes such as theft in a parking lot or unattended objects such as unattended baggage in an airport.

Further, the devices according to the present invention may advantageously be applied in camera applications such as video and camcorder applications. Thus, the devices according to the present invention may be used for motion capture and 3D-movie recording. Therein, the devices according to the present invention generally provide a large number of advantages over conventional optical devices. Thus, the devices according to the present invention generally require a lower complexity with regard to optical components. Thus, as an example, the number of lenses may be reduced as compared to conventional optical devices, such as by providing the devices according to the present invention having one lens only. Due to the reduced complexity, very compact devices are possible, such as for mobile use. Conventional optical systems having two or more lenses with high quality generally are voluminous, such as due to the general need for voluminous beam-splitters. Further, the devices according to the present invention generally may be used for focus/autofocus devices, such as autofocus cameras. Further, the devices according to the present invention may also be used in optical microscopy, especially in confocal microscopy.

Further, the devices according to the present invention generally are applicable in the technical field of automotive technology and transport technology. Thus, as an example, the devices according to the present invention may be used as distance and surveillance sensors, such as for adaptive cruise control, emergency brake assist, lane departure warning, surround view, blind spot detection, traffic sign detection, traffic sign recognition, lane recognition, rear cross traffic alert, light source recognition for adapting the head light intensity and range depending on approaching traffic or vehicles driving ahead, adaptive front-lighting systems, automatic control of high beam head lights, adaptive cut-off lights in front light systems, glare-free high beam front lighting systems, marking animals, obstacles, or the like by headlight illumination, rear cross traffic alert, and other driver assistance systems, such as advanced driver assistance systems, or other automotive and traffic applications. Further, devices according to the present invention may be used in driver assistance systems which may, particularly, be adapted for anticipating maneuvers of the driver beforehand for collision avoidance. Further, the devices according to the present invention can also be used for velocity and/or acceleration measurements, such as by analyzing a first and second time-derivative of position information gained by using the detector according to the present invention. This feature generally may be applicable in automotive technology, transportation technology or general traffic technology. Applications in other fields of technology are feasible. A specific application in an indoor positioning system may be the detection of positioning of passengers in transportation, more specifically to electronically control the use of safety systems such as airbags. Herein, the use of an airbag may, especially, be prevented in a case in which the passenger may be located within the vehicle in a manner that a use of the airbag might cause an injury, in particular a severe injury, with the passenger. Further, in vehicles such as cars, trains, planes or the like, especially in autonomous vehicles, devices according to the present invention may be used to determine whether a driver pays attention to the traffic or is distracted, or asleep, or tired, or incapable of driving, such as due to the consumption of alcohol or other drugs.

In these or other applications, generally, the devices according to the present invention may be used as standalone devices or in combination with other sensor devices, such as in combination with radar and/or ultrasonic devices. Specifically, the devices according to the present invention may be used for autonomous driving and safety issues. Further, in these applications, the devices according to the present invention may be used in combination with infrared sensors, radar sensors, which are sonic sensors, two-dimensional cameras or other types of sensors. In these applications, the generally passive nature of the devices according to the present invention is advantageous. Thus, since the devices according to the present invention generally do not require emitting signals, the risk of interference of active sensor signals with other signal sources may be avoided. The devices according to the present invention specifically may be used in combination with recognition software, such as standard image recognition software. Thus, signals and data as provided by the devices according to the present invention typically are readily processable and, therefore, generally require lower calculation power than established stereovision systems such as LIDAR. Given the low space demand, the devices according to the present invention such as cameras may be placed at virtually any place in a vehicle, such as on or behind a window screen, on a front hood, on bumpers, on lights, on mirrors or other places and the like. Various detectors according to the present invention such as one or more detectors based on the effect disclosed within the present invention can be combined, such as in order to allow autonomously driving vehicles or in order to increase the performance of active safety concepts. Thus, various devices according to the present invention may be combined with one or more other devices according to the present invention and/or conventional sensors, such as in the windows like rear window, side window or front window, on the bumpers or on the lights.

A combination of at least one device according to the present invention such as at least one detector according to the present invention with one or more rain detection sensors is also possible. This is due to the fact that the devices according to the present invention generally are advantageous over conventional sensor techniques such as radar, specifically during heavy rain. A combination of at least one device according to the present invention with at least one conventional sensing technique such as radar may allow for a software to pick the right combination of signals according to the weather conditions.

Further, the devices according to the present invention may generally be used as break assist and/or parking assist and/or for speed measurements. Speed measurements can be integrated in the vehicle or may be used outside the vehicle, such as in order to measure the speed of other cars in traffic control. Further, the devices according to the present invention may be used for detecting free parking spaces in parking lots.

Further, the devices according to the present invention may generally be used for vision, in particular for vision under difficult visibility conditions, such as in night vision, fog vision, or fume vision. For achieving this purpose, the optical detector may be sensitive at least within a wavelength range in which small particles, such as particles being present in smoke or fume, or small droplets, such as droplets being present in fog, mist or haze, may not reflect an incident light beam or only a small partition thereof. As generally known, the reflection of the incident light beam may be small or negligent in a case in which the wavelength of the incident beam exceeds the size of the particles or of the droplets, respectively. Further, might vision may be enabled by detecting thermal radiation being emitted by a bodies and objects. Thus, the optical detector may particularly be sensitive within the infrared (IR) spectral range, preferably within the near infrared (NIR) spectral range, may, thus, allow good visibility even at night, in fume, smoke, fog, mist, or haze.

Further, the devices according to the present invention may be used in the fields of medical systems and sports. Thus, in the field of medical technology, surgery robotics, e.g. for use in endoscopes, may be named, since, as outlined above, the devices according to the present invention may require a low volume only and may be integrated into other devices. Specifically, the devices according to the present invention having one lens, at most, may be used for capturing 3D information in medical devices such as in endoscopes. Further, the devices according to the present invention may be combined with an appropriate monitoring software, in order to enable tracking and analysis of movements. This may allow an instant overlay of the position of a medical device, such as an endoscope or a scalpel, with results from medical imaging, such as obtained from magnetic resonance imaging, x-ray imaging, or ultrasound imaging. These applications are specifically valuable e.g. in medical treatments where precise location information is important such as in brain surgery and long-distance diagnosis and tele-medicine. Further, the devices according to the present invention may be used in 3D-body scanning. Body scanning may be applied in a medical context, such as in dental surgery, plastic surgery, bariatric surgery, or cosmetic plastic surgery, or it may be applied in the context of medical diagnosis such as in the diagnosis of myofascial pain syndrome, cancer, body dysmorphic disorder, or further diseases. Body scanning may further be applied in the field of sports to assess ergonomic use or fit of sports equipment.

Body scanning may further be used in the context of clothing, such as to determine a suitable size and fitting of clothes. This technology may be used in the context of tailor-made clothes or in the context of ordering clothes or shoes from the internet or at a self-service shopping device such as a micro kiosk device or customer concierge device. Body scanning in the context of clothing is especially important for scanning fully dressed customers.

Further, the devices according to the present invention may be used in the context of people counting systems, such as to count the number of people in an elevator, a train, a bus, a car, or a plane, or to count the number of people passing a hallway, a door, an aisle, a retail store, a stadium, an entertainment venue, a museum, a library, a public location, a cinema, a theater, or the like. Further, the 3D-function in the people counting system may be used to obtain or estimate further information about the people that are counted such as height, weight, age, physical fitness, or the like. This information may be used for business intelligence metrics, and/or for further optimizing the locality where people may be counted to make it more attractive or safe. In a retail environment, the devices according to the present invention in the context of people counting may be used to recognize returning customers or cross shoppers, to assess shopping behavior, to assess the percentage of visitors that make purchases, to optimize staff shifts, or to monitor the costs of a shopping mall per visitor. Further, people counting systems may be used for anthropometric surveys. Further, the devices according to the present invention may be used in public transportation systems for automatically charging passengers depending on the length of transport. Further, the devices according to the present invention may be used in playgrounds for children, to recognize injured children or children engaged in dangerous activities, to allow additional interaction with playground toys, to ensure safe use of playground toys or the like.

Further, the devices according to the present invention may be used in construction tools, such as a range meter that determines the distance to an object or to a wall, to assess whether a surface is planar, to align or objects or place objects in an ordered manner, or in inspection cameras for use in construction environments or the like.

Further, the devices according to the present invention may be applied in the field of sports and exercising, such as for training, remote instructions or competition purposes. Specifically, the devices according to the present invention may be applied in the fields of dancing, aerobic, football, soccer, basketball, baseball, cricket, hockey, track and field, swimming, polo, handball, volleyball, rugby, sumo, judo, fencing, boxing, golf, car racing, laser tag, battlefield simulation etc. The devices according to the present invention can be used to detect the position of a ball, a bat, a sword, motions, etc., both in sports and in games, such as to monitor the game, support the referee or for judgment, specifically automatic judgment, of specific situations in sports, such as for judging whether a point or a goal actually was made.

Further, the devices according to the present invention may be used in the field of auto racing or car driver training or car safety training or the like to determine the position of a car or the track of a car, or the deviation from a previous track or an ideal track or the like.

The devices according to the present invention may further be used to support a practice of musical instruments, in particular remote lessons, for example lessons of string instruments, such as fiddles, violins, violas, celli, basses, harps, guitars, banjos, or ukuleles, keyboard instruments, such as pianos, organs, keyboards, harpsichords, harmoniums, or accordions, and/or percussion instruments, such as drums, timpani, marimbas, xylophones, vibraphones, bongos, congas, timbales, djembes or tablas.

The devices according to the present invention further may be used in rehabilitation and physiotherapy, in order to encourage training and/or in order to survey and correct movements. Therein, the devices according to the present invention may also be applied for distance diagnostics.

Further, the devices according to the present invention may be applied in the field of machine vision. Thus, one or more of the devices according to the present invention may be used e.g. as a passive controlling unit for autonomous driving and or working of robots. In combination with moving robots, the devices according to the present invention may allow for autonomous movement and/or autonomous detection of failures in parts. The devices according to the present invention may also be used for manufacturing and safety surveillance, such as in order to avoid accidents including but not limited to collisions between robots, production parts and living beings. In robotics, the safe and direct interaction of humans and robots is often an issue, as robots may severely injure humans when they are not recognized. Devices according to the present invention may help robots to position objects and humans better and faster and allow a safe interaction. Given the passive nature of the devices according to the present invention, the devices according to the present invention may be advantageous over active devices and/or may be used complementary to existing solutions like radar, ultrasound, 2D cameras, IR detection etc. One particular advantage of the devices according to the present invention is the low likelihood of signal interference. Therefore multiple sensors can work at the same time in the same environment, without the risk of signal interference. Thus, the devices according to the present invention generally may be useful in highly automated production environments like e.g. but not limited to automotive, mining, steel, etc. The devices according to the present invention can also be used for quality control in production, e.g. in combination with other sensors like 2-D imaging, radar, ultrasound, IR etc., such as for quality control or other purposes. Further, the devices according to the present invention may be used for assessment of surface quality, such as for surveying the surface evenness of a product or the adherence to specified dimensions, from the range of micrometers to the range of meters. Other quality control applications are feasible. In a manufacturing environment, the devices according to the present invention are especially useful for processing natural products such as food or wood, with a complex 3-dimensional structure to avoid large amounts of waste material. Further, devices according to the present invention may be used to monitor the filling level of tanks, silos etc. Further, devices according to the present invention may be used to inspect complex products for missing parts, incomplete parts, loose parts, low quality parts, or the like, such as in automatic optical inspection, such as of printed circuit boards, inspection of assemblies or sub-assemblies, verification of engineered components, engine part inspections, wood quality inspection, label inspections, inspection of medical devices, inspection of product orientations, packaging inspections, food pack inspections, or the like.

Further, the devices according to the present invention may be used in vehicles, trains, airplanes, ships, spacecraft and other traffic applications. Thus, besides the applications mentioned above in the context of traffic applications, passive tracking systems for aircraft, vehicles and the like may be named. The use of at least one device according to the present invention, such as at least one detector according to the present invention, for monitoring the speed and/or the direction of moving objects is feasible. Specifically, the tracking of fast moving objects on land, sea and in the air including space may be named. The at least one device according to the present invention, such as the at least one detector according to the present invention, specifically may be mounted on a still-standing and/or on a moving device. An output signal of the at least one device according to the present invention can be combined e.g. with a guiding mechanism for autonomous or guided movement of another object. Thus, applications for avoiding collisions or for enabling collisions between the tracked and the steered object are feasible. The devices according to the present invention are generally useful and advantageous due to a low calculation power required, an instant response and due to a passive nature of the detection system which is, generally, more difficult to detect and to disturb as compared to active systems, like e.g. radar. The devices according to the present invention are particularly useful but not limited to e.g. speed control and air traffic control devices. Further, the devices according to the present invention may be used in automated tolling systems for road charges.

The devices according to the present invention may, generally, be used in passive applications. Passive applications include guidance for ships in harbors or in dangerous areas, and for aircraft when landing or starting. Wherein, fixed, known active targets may be used for precise guidance. The same can be used for vehicles driving on dangerous but well defined routes, such as mining vehicles. Further, the devices according to the present invention may be used to detect rapidly approaching objects, such as cars, trains, flying objects, animals, or the like. Further, the devices according to the present invention can be used for detecting velocities or accelerations of objects, or to predict the movement of an object by tracking one or more of its position, speed, and/or acceleration depending on time.

Further, as outlined above, the devices according to the present invention may be used in the field of gaming. Thus, the devices according to the present invention can be passive for use with multiple objects of the same or of different size, color, shape, etc., such as for movement detection in combination with software that incorporates the movement into its content. In particular, applications are feasible in implementing movements into graphical output. Further, applications of the devices according to the present invention for giving commands are feasible, such as by using one or more of the devices according to the present invention for gesture or facial recognition. The devices according to the present invention may be combined with an active system in order to work under e.g. low light conditions or in other situations in which enhancement of the surrounding conditions is required. Additionally or alternatively, a combination of one or more devices according to the present invention with one or more IR or VIS light sources is possible. A combination of a detector according to the present invention with special devices is also possible, which can be distinguished easily by the system and its software, e.g. and not limited to, a special color, shape, relative position to other devices, speed of movement, light, frequency used to modulate light sources on the device, surface properties, material used, reflection properties, transparency degree, absorption characteristics, etc. The device can, amongst other possibilities, resemble a stick, a racquet, a club, a gun, a knife, a wheel, a ring, a steering wheel, a bottle, a ball, a glass, a vase, a spoon, a fork, a cube, a dice, a figure, a puppet, a teddy, a beaker, a pedal, a switch, a glove, jewelry, a musical instrument or an auxiliary device for playing a musical instrument, such as a plectrum, a drumstick or the like. Other options are feasible.

Further, the devices according to the present invention may be used to detect and or track objects that emit light by themselves, such as due to high temperature or further light emission processes. The light emitting part may be an exhaust stream or the like. Further, the devices according to the present invention may be used to track reflecting objects and analyze the rotation or orientation of these objects.

Further, the devices according to the present invention may generally be used in the field of building, construction and cartography. Thus, generally, one or more devices according to the present invention may be used in order to measure and/or monitor environmental areas, e.g. countryside or buildings. Therein, one or more devices according to the present invention may be combined with other methods and devices or can be used solely in order to monitor progress and accuracy of building projects, changing objects, houses, etc. The devices according to the present invention can be used for generating three-dimensional models of scanned environments, in order to construct maps of rooms, streets, houses, communities or landscapes, both from ground or air. Potential fields of application may be construction, cartography, real estate management, land surveying or the like. As an example, the devices according to the present invention may be used in vehicles capable of flight, such as drones or multicopters, in order to monitor buildings, chimneys, production sites, agricultural production environments such as fields, production plants, or landscapes, to support rescue operations, to support work in dangerous environments, to support fire brigades in a burning location indoors or outdoors, to find or monitor one or more persons, animals, or moving objects, or for entertainment purposes, such as a drone following and recording one or more persons doing sports such as skiing or cycling or the like, which could be realized by following a helmet, a mark, a beacon device, or the like. Devices according to the present invention could be used recognize obstacles, follow a predefined route, follow an edge, a pipe, a building, or the like, or to record a global or local map of the environment. Further, devices according to the present invention could be used for indoor or outdoor localization and positioning of drones, for stabilizing the height of a drone indoors where barometric pressure sensors are not accurate enough, or for the interaction of multiple drones such as concertized movements of several drones or recharging or refueling in the air or the like.

Further, the devices according to the present invention may be used within an interconnecting network of home appliances such as CHAIN (Cedec Home Appliances Interoperating Network) to interconnect, automate, and control basic appliance-related services in a home, e.g. energy or load management, remote diagnostics, pet related appliances, child related appliances, child surveillance, appliances related surveillance, support or service to elderly or ill persons, home security and/or surveillance, remote control of appliance operation, and automatic maintenance support. Further, the devices according to the present invention may be used in heating or cooling systems such as an air-conditioning system, to locate which part of the room should be brought to a certain temperature or humidity, especially depending on the location of one or more persons. Further, the devices according to the present invention may be used in domestic robots, such as service or autonomous robots which may be used for household chores. The devices according to the present invention may be used for a number of different purposes, such as to avoid collisions or to map the environment, but also to identify a user, to personalize the robot's performance for a given user, for security purposes, or for gesture or facial recognition. As an example, the devices according to the present invention may be used in robotic vacuum cleaners, floor-washing robots, dry-sweeping robots, ironing robots for ironing clothes, animal litter robots, such as cat litter robots, security robots that detect intruders, robotic lawn mowers, automated pool cleaners, rain gutter cleaning robots, window washing robots, toy robots, telepresence robots, social robots providing company to less mobile people, or robots translating and speech to sign language or sign language to speech. In the context of less mobile people, such as elderly persons, household robots with the devices according to the present invention may be used for picking up objects, transporting objects, and interacting with the objects and the user in a safe way. Further the devices according to the present invention may be used in robots operating with hazardous materials or objects or in dangerous environments. As a non-limiting example, the devices according to the present invention may be used in robots or unmanned remote-controlled vehicles to operate with hazardous materials such as chemicals or radioactive materials especially after disasters, or with other hazardous or potentially hazardous objects such as mines, unexploded arms, or the like, or to operate in or to investigate insecure environments such as near burning objects or post disaster areas, or for manned or unmanned rescue operations in the air, in the sea, underground, or the like.

Further, the devices according to the present invention may be used in household, mobile or entertainment devices, such as a refrigerator, a microwave, a washing machine, a window blind or shutter, a household alarm, an air condition devices, a heating device, a television, an audio device, a smart watch, a mobile phone, a phone, a dishwasher, a stove or the like, to detect the presence of a person, to monitor the contents or function of the device, or to interact with the person and/or share information about the person with further household, mobile or entertainment devices. Herein, the devices according to the present invention may be used to support elderly or disabled persons, blind persons, or persons with limited vision abilities, such as in household chores or at work such as in devices for holding, carrying, or picking objects, or in a safety system with optical and/or acoustical signals adapted for signaling obstacles in the environment.

The devices according to the present invention may further be used in agriculture, for example to detect and sort out vermin, weeds, and/or infected crop plants, fully or in parts, wherein crop plants may be infected by fungus or insects. Further, for harvesting crops, the devices according to the present invention may be used to detect animals, such as deer, which may otherwise be harmed by harvesting devices. Further, the devices according to the present invention may be used to monitor the growth of plants in a field or greenhouse, in particular to adjust the amount of water or fertilizer or crop protection products for a given region in the field or greenhouse or even for a given plant. Further, in agricultural biotechnology, the devices according to the present invention may be used to monitor the size and shape of plants.

Further, the devices according to the present invention may be combined with sensors to detect chemicals or pollutants, electronic nose chips, microbe sensor chips to detect bacteria or viruses or the like, Geiger counters, tactile sensors, heat sensors, or the like. This may for example be used in constructing smart robots which are configured for handling dangerous or difficult tasks, such as in treating highly infectious patients, handling or removing highly dangerous substances, cleaning highly polluted areas, such as highly radioactive areas or chemical spills, or for pest control in agriculture.

One or more devices according to the present invention can further be used for scanning of objects, such as in combination with CAD or similar software, such as for additive manufacturing and/or 3D printing. Therein, use may be made of the high dimensional accuracy of the devices according to the present invention, e.g. in x-, y- or z-direction or in any arbitrary combination of these directions, such as simultaneously. In this regard, determining a distance of an illuminated spot on a surface which may provide reflected or diffusely scattered light from the detector may be performed virtually independent of the distance of the light source from the illuminated spot. This property of the present invention is in direct contrast to known methods, such as triangulation or such as time-of-flight (TOF) methods, wherein the distance between the light source and the illuminated spot must be known a priori or calculated a posteriori in order to be able to determine the distance between the detector and the illuminated spot. In contrast hereto, for the detector according to the present invention is may be sufficient that the spot is adequately illuminated. Further, the devices according to the present invention may be used for scanning reflective surfaces, such of metal surfaces, independent whether they may comprise a solid or a liquid surface. Further, the devices according to the present invention may be used in inspections and maintenance, such as pipeline inspection gauges. Further, in a production environment, the devices according to the present invention may be used to work with objects of a badly defined shape such as naturally grown objects, such as sorting vegetables or other natural products by shape or size or cutting products such as meat or objects that are manufactured with a precision that is lower than the precision needed for a processing step.

Further, the devices according to the present invention may be used in local navigation systems to allow autonomously or partially autonomously moving vehicles or multicopters or the like through an indoor or outdoor space. A non-limiting example may comprise vehicles moving through an automated storage for picking up objects and placing them at a different location. Indoor navigation may further be used in shopping malls, retail stores, museums, airports, or train stations, to track the location of mobile goods, mobile devices, baggage, customers or employees, or to supply users with a location specific information, such as the current position on a map, or information on goods sold, or the like.

Further, the devices according to the present invention may be used to ensure safe driving of motorcycles, such as driving assistance for motorcycles by monitoring speed, inclination, upcoming obstacles, unevenness of the road, or curves or the like. Further, the devices according to the present invention may be used in trains or trams to avoid collisions.

Further, the devices according to the present invention may be used in handheld devices, such as for scanning packaging or parcels to optimize a logistics process. Further, the devices according to the present invention may be used in further handheld devices such as personal shopping devices, RFID-readers, handheld devices for use in hospitals or health environments such as for medical use or to obtain, exchange or record patient or patient health related information, smart badges for retail or health environments, or the like.

As outlined above, the devices according to the present invention may further be used in manufacturing, quality control or identification applications, such as in product identification or size identification (such as for finding an optimal place or package, for reducing waste etc.). Further, the devices according to the present invention may be used in logistics applications. Thus, the devices according to the present invention may be used for optimized loading or packing containers or vehicles. Further, the devices according to the present invention may be used for monitoring or controlling of surface damages in the field of manufacturing, for monitoring or controlling rental objects such as rental vehicles, and/or for insurance applications, such as for assessment of damages. Further, the devices according to the present invention may be used for identifying a size of material, object or tools, such as for optimal material handling, especially in combination with robots. Further, the devices according to the present invention may be used for process control in production, e.g. for observing filling level of tanks. Further, the devices according to the present invention may be used for maintenance of production assets like, but not limited to, tanks, pipes, reactors, tools etc. Further, the devices according to the present invention may be used for analyzing 3D-quality marks. Further, the devices according to the present invention may be used in manufacturing tailor-made goods such as tooth inlays, dental braces, prosthesis, clothes or the like. The devices according to the present invention may also be combined with one or more 3D-printers for rapid prototyping, 3D-copying or the like. Further, the devices according to the present invention may be used for detecting the shape of one or more articles, such as for anti-product piracy and for anti-counterfeiting purposes.

Further, the devices according to the present invention may be used in the context of gesture recognition. In this context, gesture recognition in combination with devices according to the present invention may, in particular, be used as a human-machine interface for transmitting information via motion of a body, of body parts or of objects to a machine. Herein, the information may, preferably, be transmitted via a motion of hands or hand parts, such as fingers, in particular, by pointing at objects, applying sign language, such as for deaf people, making signs for numbers, approval, disapproval, or the like, by waving the hand, such as when asking someone to approach, to leave, or to greet a person, to press an object, to take an object, or, in the field of sports or music, in a hand or finger exercise, such as a warm-up exercise. Further, the information may be transmitted by motion of arms or legs, such as rotating, kicking, grabbing, twisting, rotating, scrolling, browsing, pushing, bending, punching, shaking, arms, legs, both arms, or both legs, or a combination of arms and legs, such as for a purpose of sports or music, such as for entertainment, exercise, or training function of a machine. Further, the information may be transmitted by motion of the whole body or major parts thereof, such as jumping, rotating, or making complex signs, such as sign language used at airports or by traffic police in order to transmit information, such as “turn right”, “turn left”, “proceed”, “slow down”, “stop”, or “stop engines”, or by pretending to swim, to dive, to run, to shoot, or the like, or by making complex motions or body positions such as in yoga, pilates, judo, karate, dancing, or ballet. Further, the information may be transmitted by using a real or mock-up device for controlling a virtual device corresponding to the mock-up device, such as using a mock-up guitar for controlling a virtual guitar function in a computer program, using a real guitar for controlling a virtual guitar function in a computer program, using a real or a mock-up book for reading an e-book or moving pages or browsing through in a virtual document, using a real or mock-up pen for drawing in a computer program, or the like. Further, the transmission of the information may be coupled to a feedback to the user, such as a sound, a vibration, or a motion.

In the context of music and/or instruments, devices according to the present invention in combination with gesture recognition may be used for exercising purposes, control of instruments, recording of instruments, playing or recording of music via use of a mock-up instrument or by only pretending to have a instrument present such as playing air guitar, such as to avoid noise or make recordings, or, for conducting of a virtual orchestra, ensemble, band, big band, choir, or the like, for practicing, exercising, recording or entertainment purposes or the like.

Further, in the context of safety and surveillance, devices according to the present invention in combination with gesture recognition may be used to recognize motion profiles of persons, such as recognizing a person by the way of walking or moving the body, or to use hand signs or movements or signs or movements of body parts or the whole body as access or identification control such as a personal identification sign or a personal identification movement.

Further, in the context of smart home applications or internet of things, devices according to the present invention in combination with gesture recognition may be used for central or non-central control of household devices which may be part of an interconnecting network of home appliances and/or household devices, such as refrigerators, central heating, air condition, microwave ovens, ice cube makers, or water boilers, or entertainment devices, such as television sets, smart phones, game consoles, video recorders, DVD players, personal computers, laptops, tablets, or combinations thereof, or a combination of household devices and entertainment devices.

Further, in the context of virtual reality or of augmented reality, devices according to the present invention in combination with gesture recognition may be used to control movements or function of the virtual reality application or of the augmented reality application, such as playing or controlling a game using signs, gestures, body movements or body part movements or the like, moving through a virtual world, manipulating virtual objects, practicing, exercising or playing sports, arts, crafts, music or games using virtual objects such as a ball, chess figures, go stones, instruments, tools, brushes.

Further, in the context of medicine, devices according to the present invention in combination with gesture recognition may be used to support rehabilitation training, remote diagnostics, or to monitor or survey surgery or treatment, to overlay and display medical images with positions of medical devices, or to overlay display prerecorded medical images such as from magnetic resonance tomography or x-ray or the like with images from endoscopes or ultra sound or the like that are recorded during an surgery or treatment.

Further, in the context of manufacturing and process automation, devices according to the present invention in combination with gesture recognition may be used to control, teach, or program robots, drones, unmanned autonomous vehicles, service robots, movable objects, or the like, such as for programming, controlling, manufacturing, manipulating, repairing, or teaching purposes, or for remote manipulating of objects or areas, such as for safety reasons, or for maintenance purposes.

Further, in the context of business intelligence metrics, devices according to the present invention in combination with gesture recognition may be used for people counting, surveying customer movements, areas where customers spend time, objects, customers test, take, probe, or the like.

Further, devices according to the present invention may be used in the context of do-it-yourself or professional tools, especially electric or motor driven tools or power tools, such as drilling machines, saws, chisels, hammers, wrenches, staple guns, disc cutters, metals shears and nibblers, angle grinders, die grinders, drills, hammer drills, heat guns, wrenches, sanders, engraivers, nailers, jig saws, buiscuit joiners, wood routers, planers, polishers, tile cutters, washers, rollers, wall chasers, lathes, impact drivers, jointers, paint rollers, spray guns, morticers, or welders, in particular, to support precision in manufacturing, keeping a minimum or maximum distance, or for safety measures.

Further, the devices according to the present invention may be used to aid visually impaired persons. Further, devices according to the present invention may be used in touch screen such as to avoid direct context such as for hygienic reasons, which may be used in retail environments, in medical applications, in production environments, or the like. Further, devices according to the present invention may be used in agricultural production environments such as in stable cleaning robots, egg collecting machines, milking machines, harvesting machines, farm machinery, harvesters, forwarders, combine harvesters, tractors, cultivators, ploughs, destoners, harrows, strip tills, broadcast seeders, planters such as potato planters, manure spreaders, sprayers, sprinkler systems, swathers, balers, loaders, forklifts, mowers, or the like.

Further, devices according to the present invention may be used for selection and/or adaption of clothing, shoes, glasses, hats, prosthesis, dental braces, for persons or animals with limited communication skills or possibilities, such as children or impaired persons, or the like. Further, devices according to the present invention may be used in the context of warehouses, logistics, distribution, shipping, loading, unloading, smart manufacturing, industry 4.0, or the like. Further, in a manufacturing context, devices according to the present invention may be used in the context of processing, dispensing, bending, material handling, or the like.

The devices according to the present invention may be combined with one or more other types of measurement devices. Thus, the devices according to the present invention may be combined with one or more other types of sensors or detectors, such as a time of flight (TOF) detector, a stereo camera, a lightfield camera, a lidar, a radar, a sonar, an ultrasonic detector, or interferometry. When combining devices according to the present invention with one or more other types of sensors or detectors, the devices according to the present invention and the at least one further sensor or detector may be designed as independent devices, with the devices according to the present invention being separate from the at least one further sensor or detector. Alternatively, the devices according to the present invention and the at least one further sensor or detector may fully or partially be integrated or designed as a single device.

Thus, as a non-limiting example, the devices according to the present invention may further comprise a stereo camera. As used herein, a stereo camera is a camera which is designed for capturing images of a scene or an object from at least two different perspectives. Thus, the devices according to the present invention may be combined with at least one stereo camera.

The stereo camera's functionality is generally known in the art, since stereo cameras generally are known to the skilled person. The combination with the devices according to the present invention may provide additional distance information. Thus, the devices according to the present invention may be adapted, in addition to the stereo camera's information, to provide at least one item of information on a longitudinal position of at least one object within a scene captured by the stereo camera. Information provided by the stereo camera, such as distance information obtained by evaluating triangulation measurements performed by using the stereo camera, may be calibrated and/or validated by using the devices according to the present invention. Thus, as an example, the stereo camera may be used to provide at least one first item of information on the longitudinal position of the at least one object, such as by using triangulation measurements, and the devices according to the present invention may be used to provide at least one second item of information on the longitudinal position of the at least one object. The first item of information and the second item of information may be used to improve accuracy of the measurements. Thus, the first item of information may be used for calibrating the second item of information or vice a versa. Consequently, the devices according to the present invention, as an example, may form a stereo camera system, having the stereo camera and the devices according to the present invention, wherein the stereo camera system is adapted to calibrate the information provided by the stereo camera by using the information provided by devices according to the present invention.

Consequently, additionally or alternatively, the devices according to the present invention may be adapted to use the second item of information, provided by the devices according to the present invention, for correcting the first item of information, provided by the stereo camera. Additionally or alternatively, the devices according to the present invention may be adapted to use the second item of information, provided by the devices according to the present invention, for correcting optical distortion of the stereo camera. Further, the devices according to the present invention may adapted to calculate stereo information provided by the stereo camera, and the second item of information provided by devices according to the present invention may be used for speeding up the calculation of the stereo information.

As an example, the devices according to the present invention may be adapted to use at least one virtual or real object within a scene captured by the devices according to the present invention for calibrating the stereo camera. As an example, one or more objects and/or areas and/or spots may be used for calibration. As an example, the distance of at least one object or spot may be determined by using the devices according to the present invention, and distance information provided by the stereo camera may be calibrated by using this distance is determined by using the devices according to the present invention. For instance, at least one active light spot of the devices according to the present invention may be used as a calibration point for the stereo camera. The active light spot, as an example, may move freely in the picture.

The devices according to the present invention may be adapted to continuously or discontinuously calibrate the stereo camera by using information provided by the active distance sensor. Thus, as an example, the calibration may take place at regular intervals, continuously or occasionally.

Further, typical stereo cameras exhibit measurement errors or uncertainties which are dependent on the distance of the object. This measurement error may be reduced when combined with information provided by the devices according to the present invention.

Combinations of stereo cameras with other types of distance sensors are generally known in the art. Thus, in D. Scaramuzza et al., IEEE/RSJ International Conference on Intelligent Robots and Systems, IROS 2007, pp. 4164-4169, 2007, an extrinsic self calibration of a camera and a 3D laser range finder from natural scenes is disclosed. Similarly, in D. Klimentjew et al., IEEE Conference on Multisensor Fusion and Integration for Intelligent Systems (MFI), pages 236-241, 2010, a multi sensor fusion of camera and 3D laser range finder for object recognition is disclosed. As the skilled person will recognize, the laser range finder in these setups known in the art may simply be replaced or complemented by at least one device according to the present invention, without altering the methods and advantages disclosed by these prior art documents. For potential setups of the stereo camera, reference may be made to these prior art documents. Still, other setups and embodiments of the at least one optional stereo camera are feasible.

Preferably, for further potential details of the optical detector, the method, the human-machine interface, the entertainment device, the tracking system, the camera and the various uses of the detector, in particular with regard to the transfer device, the transversal optical sensors, the evaluation device and, if applicable, to the longitudinal optical sensor, the modulation device, the illumination source and the imaging device, specifically with respect to the potential materials, setups and further details, reference may be made to one or more of WO 2012/110924 A1, US 2012/206336 A1, WO 2014/097181 A1, US 2014/291480 A1, and WO 2016/120392 A1, the full content of all of which is herewith included by reference.

The above-described detector, the method, the human-machine interface and the entertainment device and also the proposed uses have considerable advantages over the prior art. Thus, generally, a simple and, still, efficient detector for an accurate determining a position of at least one object in space may be provided. Therein, as an example, three-dimensional coordinates of an object or a part thereof may be determined in a fast and efficient way. A further particular advantage of the thermoelectric unit is that the detector may be capable of working at room temperature, such that it may remain uncooled, thus, allowing detection without being compelled to employ any cooling systems in order to achieve reasonable, low-noise signals.

As compared to devices known in the art, the detector as proposed provides a high degree of simplicity, specifically with regard to an optical setup of the detector. This high degree of simplicity, in combination with the possibility of high precision measurements, is specifically suited for machine control, such as in human-machine interfaces and, more preferably, in gaming, tracking, scanning, and a stereoscopic vision. Thus, cost-efficient entertainment devices may be provided which may be used for a large number of gaming, entertaining, tracking, scanning, and stereoscopic vision purposes.

Summarizing, in the context of the present invention, the following embodiments are regarded as particularly preferred:

Embodiment 1: A detector for an optical detection of at least one object, comprising:
at least one longitudinal optical sensor, wherein the longitudinal optical sensor has at least one sensor region, wherein the longitudinal optical sensor is designed to generate at least one longitudinal sensor signal in a manner dependent on an illumination of the sensor region by a light beam, wherein the longitudinal sensor signal, given the same total power of the illumination, is dependent on a beam cross-section of the light beam in the sensor region, wherein the sensor region is or comprises at least one thermoelectric unit, wherein the thermoelectric unit is designed, upon illumination of the sensor region or a partition thereof by the light beam, to generate the longitudinal sensor signal as a result of at least one of a spatial variation or a temporal variation of a temperature in the thermoelectric unit; and
at least one evaluation device, wherein the evaluation device is designed to generate at least one item of information on a longitudinal position of the object by evaluating the longitudinal sensor signal.

Embodiment 2: The detector according to the preceding embodiment, wherein the thermoelectric unit comprises at least one of a thermoelectric material or a thermoelectric device.

Embodiment 3: The detector according to the preceding embodiment, wherein the thermoelectric material comprises at least one pyroelectric material.

Embodiment 4: The detector according to the preceding embodiment, wherein the temporal variation of the temperature in the pyroelectric material is designed to generate the longitudinal sensor signal.

Embodiment 5: The detector according to the preceding embodiment, wherein the longitudinal sensor signal comprises a change in a voltage across the pyroelectric material.

Embodiment 6: The detector according to the preceding embodiment, wherein the pyroelectric material comprises at least one of an inorganic pyroelectric material or an organic pyroelectric substance.

Embodiment 7: The detector according to the preceding embodiment, wherein the inorganic pyroelectric material comprises a polar crystalline structure.

Embodiment 8: The detector according to any one of the two preceding embodiments, wherein the inorganic pyroelectric material comprises at least one of lithium tantalate (LiTaO3), gallium nitride (GaN), cesium nitrate (CsNO3), lead zirconate titanate (Pb[ZrₓTi₁₋ₓ]₃, wherein 0<x<1; PZT), a mixtures and/or a doped variant thereof.

Embodiment 9: The detector according to any one of the three preceding embodiments, wherein the organic pyroelectric substance comprises at least one of a polyvinyl fluoride, a phenylpyridine derivatives, cobalt phthalocyanine, L-alanine, triglycine sulfate, a mixture and/or a doped variant thereof.

Embodiment 10: The detector according to any one of the six preceding embodiments, wherein the pyroelectric material is designed to generate the longitudinal sensor signal upon the illumination of the sensor region by the light beam having a wavelength from 1.5 μm to 30 μm, preferably from 2 μm to 20 μm.

Embodiment 11: The detector according to any one of the seven preceding embodiments, wherein the pyroelectric material is provided as a layer of the pyroelectric material.

Embodiment 12: The detector according to the preceding embodiment, wherein the layer exhibits a thickness from 1 nm to 2 mm, preferably from 2 nm to 1 mm, more preferred from 2 nm to 0.5 mm.

Embodiment 13: The detector according to any of the two preceding embodiments, wherein at least two electrodes contact the layer of the pyroelectric material, wherein the at least two electrodes are applied at different locations of the layer.

Embodiment 14: The detector according to the preceding embodiment, wherein the at least two electrodes are applied to the same side of the layer.

Embodiment 15: The detector according to any of the two preceding embodiments, wherein the at least one layer of the pyroelectric material is directly or indirectly applied to at least one substrate.

Embodiment 16: The detector according to any of the two preceding embodiments, wherein the substrate is an insulating substrate.

Embodiment 17: The detector according to any of the two preceding embodiments, wherein the substrate is at least partially transparent or translucent over a wavelength from 1.5 μm to 30 μm, preferably from 2 μm to 20 μm.

Embodiment 18: The detector according to any of the seven preceding embodiments, wherein the sensor region of the longitudinal optical sensor is formed by a surface of the layer of the pyroelectric material, wherein the surface faces towards the object or faces away from the object.

Embodiment 19: The detector according to any of the eight preceding embodiments, wherein the sensor region of the longitudinal optical sensor is exactly one continuous sensor region, wherein the longitudinal sensor signal is a uniform sensor signal for the entire sensor region.

Embodiment 20: The detector according to embodiment 2, wherein the thermoelectric device comprises at least one thermocouple, wherein the thermocouple comprises at least two different kinds of electrical conductors, wherein the different kinds of the electrical conductors are designed to form at least two spatially separated electrical junctions, wherein, upon a temperature difference between at least one of the spatially separated electrical junctions, a voltage is generated between the spatially separated electrical junctions.

Embodiment 21: The detector according to the preceding embodiment, wherein the thermoelectric device comprises at least two thermocouples, wherein the at least two thermocouples are arranged in series.

Embodiment 22: The detector according to the preceding embodiment, wherein the thermoelectric device comprises a multitude of thermocouples (thermopile), wherein the multitude of the thermocouples is arranged in series.

Embodiment 23: The detector according to the preceding embodiment, wherein the thermopile comprises 2 to 1000 thermocouples, preferably 5 to 500 thermocouples, most preferred 10 to 120 thermocouples.

Embodiment 24: The detector according to any one of four preceding embodiments, wherein the spatial variation of the temperature in the thermocouple is designed to generate the longitudinal sensor signal.

Embodiment 25: The detector according to the preceding embodiment, wherein the longitudinal sensor signal comprises an output voltage being proportional to the spatial variation of the temperature in the thermocouple.

Embodiment 26: The detector according to any one of the six preceding embodiments, wherein the spatial variation of the temperature in the thermocouple comprises a local temperature difference or a temperature gradient.

Embodiment 27: The detector according to the preceding embodiment, wherein the thermocouple is arranged in the sensor region in manner that the light beam is designed to illuminate a first kind of the electrical junctions (hot junction), wherein a second kind of the electrical junctions (cold junction) is connected to a heat sink.

Embodiment 28: The detector according to the preceding embodiment, wherein the longitudinal sensor signal comprises an output voltage between the first kind of the electrical junctions and the second kind of the electrical junctions in the thermocouple.

Embodiment 29: The detector according to the preceding embodiment, wherein the output voltage is proportional to the variation of the temperature between the first kind of the electrical junctions and the second kind of the electrical junctions in the thermocouple.

Embodiment 30: The detector according to any one of the ten preceding embodiments, wherein the electrical conductors comprise a thin film of an electrically conducting material.

Embodiment 31: The detector according to the preceding embodiment, wherein the sensor region of the at least one thermocouple exhibits an active area from 0.01 mm² to 100 mm², preferably from 0.03 mm² to 30 mm².

Embodiment 32: The detector according to any one of the twelve preceding embodiments, wherein the electrical conductors exhibit an alternating arrangement of an n-type conducting material and a p-type conducting material.

Embodiment 33: The detector according to the preceding embodiment, wherein the n-type conducting material comprises at least one of Sb or n-type Si.

Embodiment 34: The detector according to the preceding embodiment, wherein the p-type conducting material comprises at least one of Bi, Au, Al, or p-type Si.

Embodiment 35: The detector according to any one of the fifteen preceding embodiments, wherein the detector comprises a substrate.

Embodiment 36: The detector according to the preceding embodiment, wherein the first kind of the electrical junctions (hot junction) is coated with an energy absorber suspended on a thin membrane and thermally isolated from the substrate.

Embodiment 37: The detector according to any one of the two preceding embodiments, wherein the heat sink is or comprises a partition of the substrate.

Embodiment 38: The detector according to any one of the seventeen preceding embodiments, wherein the at least one thermocouple is designed to detect electromagnetic radiation in at least one of the UV, visible, NIR, mid-IR or FIR spectral range.

Embodiment 39: The detector according to the preceding embodiment, wherein the at least one thermocouple exhibits a flat response to the electromagnetic radiation from the UV spectral range to the FIR spectral range, wherein the flat response indicates a variation of the response less than 50%.

Embodiment 40: The detector according to any one of the two preceding embodiments, further comprising at least one optical band-pass filter.

Embodiment 41: The detector according to the preceding embodiment, wherein the optical band-pass filter is designed to provide a spectral sensitivity for a selected wavelength range.

Embodiment 42: The detector according to any one of the preceding embodiments, wherein the detector is uncooled.

Embodiment 43: The detector according to any one of the preceding embodiments, wherein the evaluation device is designed to generate the at least one item of information on the longitudinal position of the object from at least one predefined relationship between the geometry of the illumination and a relative positioning of the object with respect to the detector, preferably taking account of a known power of the illumination and optionally taking account of a modulation frequency with which the illumination is modulated.

Embodiment 44: The detector according to any one of the preceding embodiments, wherein the evaluation device is adapted to normalize the longitudinal sensor signals and to generate the information on the longitudinal position of the object independent from an intensity of the light beam.

Embodiment 45: The detector according to the preceding embodiment, wherein the evaluation device is adapted to recognize whether the light beam widens or narrows, by comparing the longitudinal sensor signals of different longitudinal sensors.

Embodiment 46: The detector according to any one of the preceding embodiments, wherein the evaluation device is adapted to generate the at least one item of information on the longitudinal position of the object by determining a diameter of the light beam from the at least one longitudinal sensor signal.

Embodiment 47: The detector according to the preceding embodiment, wherein the evaluation device is adapted to compare the diameter of the light beam with known beam properties of the light beam in order to determine the at least one item of information on the longitudinal position of the object, preferably from a known dependency of a beam diameter of the light beam on at least one propagation coordinate in a direction of propagation of the light beam and/or from a known Gaussian profile of the light beam.

Embodiment 48: The detector according to any one of the preceding embodiments, wherein the detector furthermore has at least one modulation device for modulating the illumination.

Embodiment 49: The detector according to the preceding embodiment, wherein the detector is designed to detect at least two longitudinal sensor signals in the case of different modulations, in particular at least two sensor signals at respectively different modulation frequencies, wherein the evaluation device is designed to generate the at least one item of information on the longitudinal position of the object by evaluating the at least two longitudinal sensor signals.

Embodiment 50: The detector according to any of the preceding embodiments, wherein the longitudinal optical sensor is furthermore designed in such a way that the longitudinal sensor signal, given the same total power of the illumination, is dependent on a modulation frequency of a modulation of the illumination.

Embodiment 51: The detector according to any one of the preceding embodiments, wherein the detector comprises at least two longitudinal optical sensors.

Embodiment 52: The detector according to the preceding embodiment, wherein the at least two longitudinal optical sensors are arranged as an array.

Embodiment 53: The detector according to any one of the two preceding embodiments, wherein the array of the longitudinal optical sensors is arranged perpendicular to the optical axis.

Embodiment 54: The detector according to any one of the preceding embodiments, furthermore comprising at least one illumination source.

Embodiment 55: The detector according to the preceding embodiment, wherein the illumination source is selected from: an illumination source, which is at least partly connected to the object and/or is at least partly identical to the object; an illumination source which is designed to at least partly illuminate the object with a primary radiation.

Embodiment 56: The detector according to the preceding embodiment, wherein the light beam is generated by a reflection of the primary radiation on the object and/or by light emission by the object itself, stimulated by the primary radiation.

Embodiment 57: The detector according to the preceding embodiment, wherein the spectral sensitivities of the longitudinal optical sensor is covered by the spectral range of the illumination source.

Embodiment 58: The detector according to any one of the preceding embodiments, wherein the detector further comprises at least one transfer device, the transfer device being adapted to guide the light beam onto the optical sensor.

Embodiment 59: The detector according to the preceding embodiment, wherein the transfer device comprises at least one of an optical lens, a mirror, a beam splitter, an optical filter.

Embodiment 60: The detector according to any one of the preceding embodiments, further comprising at least one transversal optical sensor, the transversal optical sensor being adapted to determine a transversal position of the light beam traveling from the object to the detector, the transversal position being a position in at least one dimension perpendicular to an optical axis of the detector, the transversal optical sensor being adapted to generate at least one transversal sensor signal, wherein the evaluation device is further designed to generate at least one item of information on a transversal position of the object by evaluating the transversal sensor signal.

Embodiment 61: The detector according to the preceding embodiment, wherein the transversal optical sensor is or comprises at least one further thermoelectric unit, wherein, upon illumination of the further thermoelectric unit by the light beam, at least one of a spatial variation or a temporal variation of the temperature in the further thermoelectric unit is further designed to generate the transversal sensor signal.

Embodiment 62: The detector according to the preceding embodiment, wherein the further thermoelectric unit comprises a pyroelectric material according to any one of embodiments referring to a pyroelectric material.

Embodiment 63: The detector according to any one of the preceding embodiments, wherein the pyroelectric material is provided as a layer of the pyroelectric material.

Embodiment 64: The detector according to any of the four preceding embodiments, wherein the transversal optical sensor further comprises at least two electrodes contacting the pyroelectric material, wherein the electrodes are designed to provide the at least one transversal sensor signal.

Embodiment 65: The detector according to the preceding embodiment, wherein the electrodes are split electrodes, wherein each split electrode comprises at least two partial electrodes.

Embodiment 66: The detector according to the preceding embodiment, wherein at least four partial electrodes are provided, each of the partial electrodes, preferably, comprising a T shape.

Embodiment 67: The detector according to any one of the two preceding embodiments, wherein electrical currents through the partial electrodes are dependent on a position of the light beam in the sensor region.

Embodiment 68: The detector according to the preceding embodiment, wherein the transversal optical sensor is adapted to generate the transversal sensor signal in accordance with the electrical currents through the partial electrodes.

Embodiment 69: The detector according to any of the two preceding embodiments, wherein the detector, preferably the transversal optical sensor and/or the evaluation device, is adapted to derive the information on the transversal position of the object from at least one ratio of the currents through the partial electrodes.

Embodiment 70: The detector according to any of the ten preceding embodiments, wherein the transversal optical sensor and the at least one longitudinal optical sensor are stacked along the optical axis such that a light beam travelling along the optical axis both impinges the transversal optical sensor and the at least one longitudinal optical sensor.

Embodiment 71: The detector according to the preceding embodiment, wherein the light beam subsequently passes through the transversal optical sensor and the at least one longitudinal optical sensor or vice versa.

Embodiment 72: The detector according to the preceding embodiment, wherein the light beam passes through the transversal optical sensor before impinging on the at least one longitudinal optical sensor.

Embodiment 73: The detector according to any of the twelve preceding embodiments, wherein the transversal sensor signal is selected from the group consisting of a current and a voltage or any signal derived thereof.

Embodiment 74: The detector according to any one of the preceding embodiments, wherein the detector further comprises at least one imaging device.

Embodiment 75: The detector according to the preceding claim, wherein the imaging device is located in a position furthest away from the object.

Embodiment 76: The detector according to the preceding claim, wherein the imaging device is an intransparent device.

Embodiment 77: The detector according to any of the three preceding embodiments, wherein the light beam passes through the at least one longitudinal optical sensor before illuminating the imaging device.

Embodiment 78: The detector according to any of the four preceding embodiments, wherein the imaging device comprises a camera.

Embodiment 79: The detector according to any of the five preceding embodiments, wherein the imaging device comprises at least one of: an inorganic camera; a monochrome camera; a multichrome camera; a full-color camera; a pixelated inorganic chip; a pixelated organic camera; a CCD chip, preferably a multi-color CCD chip or a full-color CCD chip; a CMOS chip; an IR camera; an RGB camera.

Embodiment 80: An arrangement comprising at least two detectors according to any of the preceding embodiments.

Embodiment 81: The arrangement according to any of the two preceding embodiments, wherein the arrangement further comprises at least one illumination source.

Embodiment 82: A human-machine interface for exchanging at least one item of information between a user and a machine, in particular for inputting control commands, wherein the human-machine interface comprises at least one detector according to any of the preceding embodiments relating to a detector, wherein the human-machine interface is designed to generate at least one item of geometrical information of the user by means of the detector wherein the human-machine interface is designed to assign to the geometrical information at least one item of information, in particular at least one control command.

Embodiment 83: The human-machine interface according to the preceding embodiment, wherein the at least one item of geometrical information of the user is selected from the group consisting of: a position of a body of the user; a position of at least one body part of the user; an orientation of a body of the user; an orientation of at least one body part of the user.

Embodiment 84: The human-machine interface according to any of the two preceding embodiments, wherein the human-machine interface further comprises at least one beacon device connectable to the user, wherein the human-machine interface is adapted such that the detector may generate an information on the position of the at least one beacon device.

Embodiment 85: The human-machine interface according to the preceding embodiment, wherein the beacon device comprises at least one illumination source adapted to generate at least one light beam to be transmitted to the detector.

Embodiment 86: An entertainment device for carrying out at least one entertainment function, in particular a game, wherein the entertainment device comprises at least one human-machine interface according to any of the preceding embodiments referring to a human-machine interface, wherein the entertainment device is designed to enable at least one item of information to be input by a player by means of the human-machine interface, wherein the entertainment device is designed to vary the entertainment function in accordance with the information.

Embodiment 87: A tracking system for tracking the position of at least one movable object, the tracking system comprising at least one detector according to any of the preceding embodiments referring to a detector, the tracking system further comprising at least one track controller, wherein the track controller is adapted to track a series of positions of the object, each comprising at least one item of information on a position of the object at a specific point in time.

Embodiment 88: The tracking system according to the preceding embodiment, wherein the tracking system further comprises at least one beacon device connectable to the object, wherein the tracking system is adapted such that the detector may generate an information on the position of the object of the at least one beacon device.

Embodiment 89: A scanning system for determining at least one position of at least one object, the scanning system comprising at least one detector according to any of the preceding embodiments relating to a detector, the scanning system further comprising at least one illumination source adapted to emit at least one light beam configured for an illumination of at least one dot located at at least one surface of the at least one object, wherein the scanning system is designed to generate at least one item of information about the distance between the at least one dot and the scanning system by using the at least one detector.

Embodiment 90: The scanning system according to the preceding embodiment, wherein the illumination source comprises at least one artificial illumination source, in particular at least one laser source and/or at least one incandescent lamp and/or at least one semiconductor light source.

Embodiment 91: The scanning system according to any one of the two preceding embodiments, wherein the illumination source emits a plurality of individual light beams, in particular an array of light beams exhibiting a respective pitch, in particular a regular pitch.

Embodiment 92: The scanning system according to any one of the three preceding embodiments, wherein the scanning system comprises at least one housing.

Embodiment 93: The scanning system according to the preceding embodiment, wherein the at least one item of information about the distance between the at least one dot and the scanning system distance is determined between the at least one dot and a specific point on the housing of the scanning system, in particular a front edge or a back edge of the housing.

Embodiment 94: The scanning system according to any one of the two preceding embodiments, wherein the housing comprises at least one of a display, a button, a fastening unit, a leveling unit.

Embodiment 95: A stereoscopic system comprising at least one tracking system according to any one of the embodiments which refer to the tracking system and at least one scanning system according to any one of the embodiments which refer to the scanning system, wherein the tracking system and the scanning system each comprise at least one optical sensor which are placed in a collimated arrangement in such a manner that they are aligned in an orientation parallel to the optical axis of the stereoscopic system and, concurrently, exhibit an individual displacement with respect to the orientation perpendicular to the optical axis of the stereoscopic system.

Embodiment 96: The stereoscopic system according to the preceding embodiment, wherein the tracking system and the scanning system each comprise at least one longitudinal optical sensor, wherein the sensor signals of the longitudinal optical sensors are combined for determining the item of information on the longitudinal position of the object.

Embodiment 97: The stereoscopic system according to the preceding embodiment, wherein the sensor signals of the longitudinal optical sensors are distinguishable with respect to each other by applying a different modulation frequency.

Embodiment 98: The stereoscopic system according to the preceding embodiment, wherein the stereoscopic system further comprises at least one transversal optical sensor, wherein the sensor signals of the transversal optical sensor are used for determining the item of information on the transversal position of the object.

Embodiment 99: The stereoscopic system according to the preceding embodiment, wherein a stereoscopic view of the object is obtained by combining the item of information on the longitudinal position of the object and the item of information on the transversal position of the object.

Embodiment 100: A camera for imaging at least one object, the camera comprising at least one detector according to any one of the preceding embodiments referring to a detector.

Embodiment 101: A method for an optical detection of at least one object, in particular by using a detector according to any of the preceding embodiments relating to a detector, comprising the following steps:
generating at least one longitudinal sensor signal by using at least one longitudinal optical sensor, wherein the longitudinal optical sensor has at least one sensor region, wherein the at least one longitudinal sensor signal is generated in a manner dependent on an illumination of the sensor region by a light beam, wherein the longitudinal sensor signal, given the same total power of the illumination, is dependent on a beam cross-section of the light beam in the sensor region, wherein the sensor region is or comprises at least one thermoelectric unit, wherein, upon illumination of the sensor region or a partition thereof by the light beam, at least one of a spatial variation or a temporal variation of the temperature in the thermoelectric unit is designed to generate the longitudinal sensor signal; and
generating at least one item of information on a longitudinal position of the object by evaluating the longitudinal sensor signal.

Embodiment 102: A use of a detector according to any one of the preceding embodiments relating to a detector for a purpose of use, selected from the group consisting of: gas sensing, fire detection, flame detection, heat detection, smoke detection, combustion monitoring, spectroscopy, temperature sensing, motion sensing, industrial monitoring, chemical sensing, exhaust gas monitoring, a distance measurement, in particular in traffic technology; a position measurement, in particular in traffic technology; an entertainment application; a security application; a human-machine interface application; a tracking application; a scanning application; a photography application; an imaging application or camera application; a mapping application for generating maps of at least one space; a homing or tracking beacon detector for vehicles; a distance and/or position measurement of objects with a thermal signature (hotter or colder than background); a stereoscopic vision application; a machine vision application; a robotic application.

### BRIEF DESCRIPTION OF THE FIGURES

Further optional details and features of the invention are evident from the description of preferred exemplary embodiments which follows in conjunction with the dependent claims. In this context, the particular features may be implemented alone or with features in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an exemplary embodiment of a detector according to the present invention;

FIGS. 2A and 2B show exemplary embodiments of the longitudinal optical sensor having a sensor region, wherein the sensor region comprises a layer of a pyroelectric material (FIG. 2A) or a thermopile (FIG. 2B), respectively;

FIGS. 3A and 3B show an exemplary embodiment of a transversal optical sensor having a layer of a pyroelectric material (FIG. 3A) and an exemplary schematic setup of an evaluation scheme for evaluating the transversal sensor signals (FIG. 3B), respectively; and

FIG. 4 shows an exemplary embodiment of an optical detector, a detector system, a human-machine interface, an entertainment device, a tracking system and a camera according to the present invention.

### EXEMPLARY EMBODIMENTS

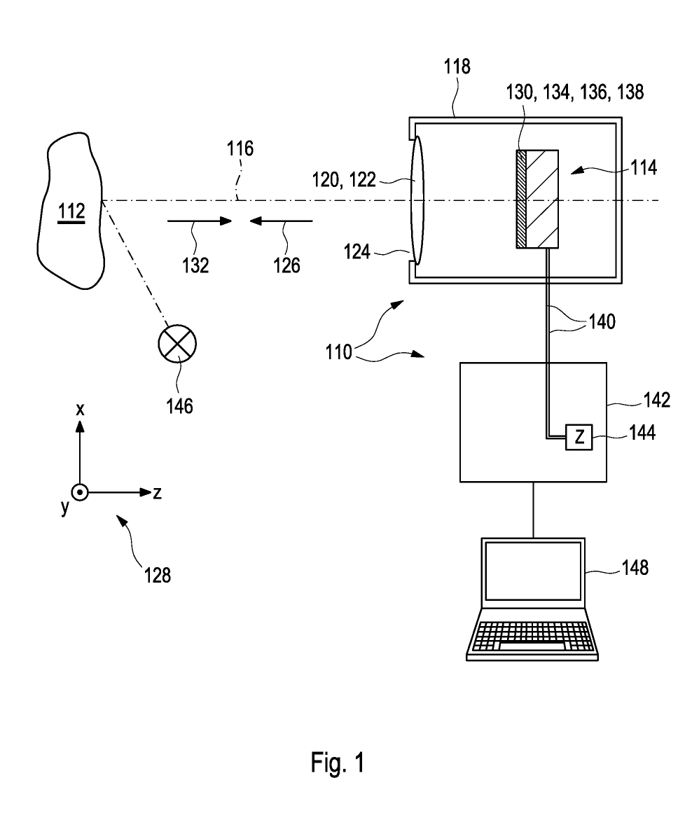

FIG. 1 illustrates, in a highly schematic fashion, an exemplary embodiment of an optical detector 110 according to the present invention for determining a position of at least one object 112. The optical detector 110 comprises at least one longitudinal optical sensor 114, which, in this particular embodiment, is arranged along an optical axis 116 of the detector 110. Specifically, the optical axis 116 may be an axis of symmetry and/or of rotation of the setup of the optical sensors 114. The optical sensors 114 may be located inside a housing 118 of the detector 110. Further, at least one transfer device 120 may be comprised, preferably a refractive lens 122. An opening 124 in the housing 118, which may, particularly, be located concentrically with regard to the optical axis 116, preferably defines a direction of view 126 of the detector 110. A coordinate system 128 may be defined, in which a direction parallel or antiparallel to the optical axis 116 is defined as a longitudinal direction, whereas directions perpendicular to the optical axis 116 may be defined as transversal directions. In the coordinate system 128, symbolically depicted in FIG. 1, a longitudinal direction is denoted by z and transversal directions are denoted by x and y, respectively. However, other types of coordinate systems 128 are feasible.

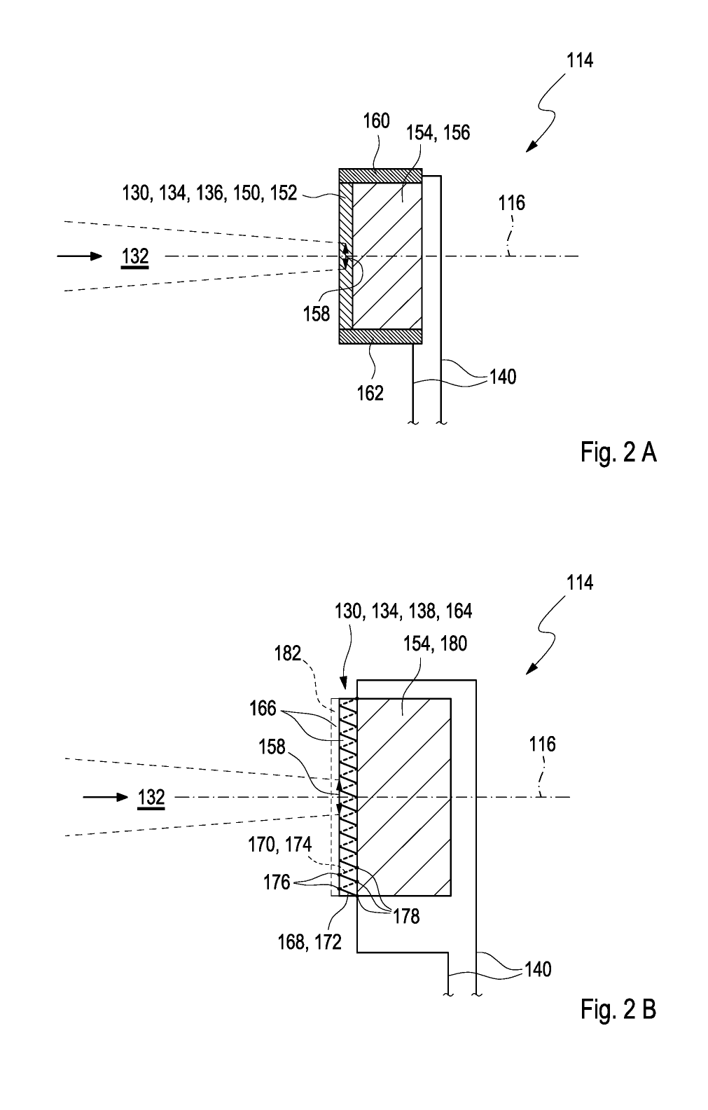

Further, the longitudinal optical sensor 114 is designed to generate at least one longitudinal sensor signal in a manner dependent on an illumination of a sensor region 130 of the longitudinal optical sensor 114 by a light beam 132. In accordance with the present invention, the sensor region 130 comprises at least one thermoelectric unit 134, wherein, upon illumination of the sensor region 130 by the light beam 132, at least one of a spatial variation or a temporal variation of a temperature in the thermoelectric unit 134 is designed to generate the longitudinal sensor signal. Consequently, the resulting longitudinal sensor signal as provided by the longitudinal optical sensor 114 upon impingement by the light beam 132 depends on the spatial variation or a temporal variation of a temperature in the thermoelectric unit 134 in the sensor region 130. As illustrated in FIGS. 2A and 2B in more detail, the thermoelectric unit 134 may, preferably, comprise at least one of a thermoelectric material 136 or a thermoelectric device 138. Via a signal lead 140, the longitudinal sensor signal may be transmitted to an evaluation device 142.

The evaluation device 142 is, generally, designed to generate at least one item of information on a position of the object 112 by evaluating the sensor signal of the longitudinal optical sensor 114. For this purpose, the evaluation device 142 may comprise one or more electronic devices and/or one or more software components, in order to evaluate the sensor signals, which are symbolically denoted by a longitudinal evaluation unit 144 (denoted by “z”). As will be explained below in more detail, the evaluation device 142 may be adapted to determine the at least one item of information on the longitudinal position of the object 112 by comparing more than one longitudinal sensor signals of the longitudinal optical sensor 114.

The light beam 132 for illumining the sensor region 130 of the longitudinal optical sensor 114 may be generated by a light-emitting object 112. Alternatively or in addition, the light beam 132 may be generated by a separate illumination source 146, which may include an ambient light source and/or an artificial light source, such as a light-emitting diode, being adapted to illuminate the object 112 in a manner that the object 112 may be able to reflect at least a part of the light generated by the illumination source 146 in a manner that the light beam 132 may be configured to reach the sensor region 130 of the longitudinal optical sensor 114, preferably by entering the housing 118 of the optical detector 110 through the opening 124 along the optical axis 116. In a specific embodiment (not depicted here), the illumination source 146 may be a modulated light source, wherein one or more modulation properties of the illumination source 146 may be controlled by at least one optional modulation device. Alternatively or in addition, the modulation may be effected in a beam path between the illumination source 146 and the object 112 and/or between the object 112 and the longitudinal optical sensor 114. Further possibilities may be conceivable. In this specific embodiment, it may be advantageous taking into account one or more of the modulation properties, in particular the modulation frequency, when evaluating the sensor signal of the longitudinal optical sensor 114 for determining the at least one item of information on the position of the object 112.

Generally, the evaluation device 142 may be part of a data processing device 148 and/or may comprise one or more data processing devices 148. The evaluation device 142 may be fully or partially integrated into the housing 118 and/or may fully or partially be embodied as a separate device which is electrically connected in a wireless or wire-bound fashion to the longitudinal optical sensor 114. The evaluation device 142 may further comprise one or more additional components, such as one or more electronic hardware components and/or one or more software components, such as one or more measurement units and/or one or more evaluation units and/or one or more controlling units (not depicted here).

FIGS. 2A and 2B show exemplary embodiments of the longitudinal optical sensor 114. Herein, FIG. 2A schematically depicts a preferred embodiment in which the thermoelectric unit 134 as comprised within in the sensor region 130 of the longitudinal optical sensor 114 is arranged in form of the thermoelectric material 136. In particular, the thermoelectric material 136 comprises at least one pyroelectric material 150, the temporal variation of the temperature in the pyroelectric material 150 is designed to generate the longitudinal sensor signal which, as described above, may, thus, comprise a change in a voltage across the pyroelectric material 150. In the preferred embodiment as illustrated in FIG. 2A, the pyroelectric material 150 may comprise an inorganic pyroelectric material. In particular, the pyroelectric material 150 may comprise a layer 152 of lithium tantalate (LiTaO3), gallium nitride (GaN), cesium nitrate (CsNO3), lead zirconate titanate (Pb[ZrxTi1-x]O3, wherein 0<x<1; PZT), a mixture and/or a doped variant thereof. Herein, the layer 152 of the pyroelectric material 150 may be located on a substrate 154, in particular, a transparent insulating substrate 156, wherein the substrate 154 is at least partially transparent or translucent over a wavelength from 1.5 μm to 30 μm, preferably from 2 μm to 20 μm. Alternatively, the pyroelectric material 150 may comprise a layer 152 of an organic pyroelectric substance, such as a polyvinyl fluoride, a phenylpyridine derivative, cobalt phthalocyanine, L-alanine, triglycine sulfate, a mixture and/or a doped variant thereof. Preferably, the layer 152 of the pyroelectric material 150 may exhibit a thickness from 1 nm to 2 mm, preferably from 2 nm to 1 mm, more preferred from 2 nm to 0.5 mm.

Thus, the sensor region 130 of the longitudinal optical sensor 114 is illuminated by the light beam 132. Given the same total power of the illumination, the longitudinal sensor signal, therefore, depends on a beam cross-section 158 of the light beam in the sensor region 130, which may also be denominated as a “spot size”, generated by the incident beam 132 within the sensor region 130. Thus, the observable property that the longitudinal sensor signal depends on an extent of the illumination of the sensor region 130 by an incident light beam 132 particularly accomplishes that two light beams 132 which may comprise the same total power but may exhibit different beam cross-sections 158 in the sensor region 130 may provide different values for the longitudinal sensor signal and are, consequently, distinguishable with respect to each other.

As further schematically depicted in FIG. 2A, the longitudinal optical sensor 114 may, comprise two or more electrodes 160, 162 which may, preferably, be designed in order to contact the layer 152 of the pyroelectric material 150, wherein the electrodes 160, 162 may, preferably, be applied at different locations of the layer 152, in particular, to ensure that they may not contact each other in a direct manner. However, irrespective of their detailed arrangement, the electrodes 160, 162 may, in particular, be designed to provide the longitudinal sensor signal via the signal leads 140 to the evaluation device 142, such as for further processing.

As a result of the nature of the pyroelectric materials 150 as provided above, the longitudinal optical sensor 114 may, thus, be able to detect electromagnetic radiation in the mid-infrared (mid-IR) spectral range, i.e. from 1.5 μm to 30 μm, preferably from 2 μm to 20 μm. Thus, the detector 110 may, preferably, be used as an IR detector, in particular as a mid-IR detector. However, other embodiments may, in principal, also be feasible.

FIG. 2B schematically depicts a further preferred embodiment in which the thermoelectric unit 134 as comprised within in the sensor region 130 of the longitudinal optical sensor 114 is arranged in form of the thermoelectric device 138. Herein, the thermoelectric device 138 may, preferably, be arranged in form of a thermopile 164 which, accordingly, comprises a multitude of thermocouples 166, wherein the multitude of the thermocouples 166 are arranged in series. Preferably, the thermopile may comprise 2 to 1000 thermocouples 166, preferably 5 to 500 thermocouples 166, most preferred 10 to 120 thermocouples 166. As generally known, each of the thermocouples 166 comprises at least two different kinds of electrical conductors 168, 170 which are, preferably, provided in an alternating arrangement. Herein, the electrical conductors 168, 170 comprise two different kind of electrically conducting materials, such as a highly conducting metal, such as Cu, and a poorly conducting metal, such as Fe, or, preferably an n-type conducting material 172 and a p-type conducting material 174. In a particularly preferred embodiment, the n-type conducting material 172 may comprise Sb or n-type Si while the p-type conducting material 174 may comprise Bi, Au, Al, or p-type Si. However, other kinds of electrically conducting materials may also be feasible.

Further, in each of the thermocouples 166 of the thermopile 168 the different kinds of the electrical conductors 168, 170 are designed to form spatially separated electrical junctions 176, 178, i.e. a first kind of the electrical junctions 176 and a second kind of the electrical junctions 178. As generally known, a temperature difference that may occur between the spatially separated electrical junctions 176, 178 may generate an electrical voltage between the spatially separated electrical junctions 176, 178 which may constitute the longitudinal sensor signal which may be provided via the signal leads 140 to the evaluation device 142, such as for further processing. Thus, the spatial variation of the temperature one or more of the thermocouples 166 of the thermopile 168 is designed to generate the longitudinal sensor signal.

As schematically depicted in FIG. 2B, the light beam 132 may be designed to illuminate the multitude of the thermocouples 166 as comprised in sensor region 130 of the longitudinal optical sensor 114 in a manner the light beam 132 may illuminate within the beam cross-section 158 only the first kind of the electrical junctions 176 which may, thus, also be denominated as the “hot junctions” while the second kind of the electrical junctions 176, also denoted as the “cold junction” are arranged such that they may not be illuminable by the light beam 132. Rather, the second kind of the electrical junctions 176, i.e. the cold junctions, may be connected to the substrate 154 which may function here as a heat sink 180. By way of example, the first kind of the electrical conductors 176, i.e. the hot junctions, may, thus, be coated with an energy absorber being suspended on a thin membrane and thermally isolated from the substrate 154.

As a result of the setup of the thermopile 164 as exemplary depicted in FIG. 2B, the longitudinal optical sensor 114 may, thus, be able to detect electromagnetic radiation in at least one of the UV, visible, NIR, mid-IR or FIR spectral range. Herein, the thermopile 164 may exhibit a flat response to the electromagnetic radiation from the UV spectral range via the visible, the NIR and the mid-IR to the FIR spectral range, wherein the flat response may indicate a variation of the response of less than 50%, preferably less than 20%, most preferred less than 10%. Thus, on one hand, this kind of detector 110 may, preferably, be used as a wide-range optical detector. On the other hand, at least one optical band-pass filter 182 may, additionally, be employed, wherein the optical band-pass filter may be designed to provide a spectral sensitivity for a wavelength range that may be selected from the wide spectral range as provided by the thermopile 164. Other embodiments may, in principal, also be feasible.

A main advantage of the detector 110 comprising any one of embodiments of the longitudinal optical sensors 114 as depicted in FIGS. 2A and 2B is that the detector 110 may remain uncooled, such that no cooling equipment may be required for operation.

As described above, the optical detector 110 may comprise a single longitudinal optical sensor 114 or, as e.g. disclosed in WO 2014/097181 A1, a stack of longitudinal optical sensors 114, particularly in combination with one or more transversal optical sensors 184. Hereby, using a layer of the organic photoconductive materials in the longitudinal optical sensors 114 may, particularly, by preferred, mainly due to the transparency, semitransparency or translucency of the organic photoconductive materials. As an example, one or more transversal optical sensors 184 may be located on a side of the stack of longitudinal optical sensors 114 facing towards the object. Alternatively or additionally, one or more transversal optical sensors 184 may be located on a side of the stack of longitudinal optical sensors 114 facing away from the object. Again, additionally or alternatively, one or more transversal optical sensors 184 may be interposed in between the longitudinal optical sensors 114 of the stack. However, embodiments which may only comprise a single longitudinal optical 114 sensor but no transversal optical sensor 184 may still be possible, such as in a case wherein only determining the depth, i.e. the z-coordinate, of the object may be desired.

Thus, in a case in which determining the x- and/or y-coordinate of the object in addition to the z-coordinate may be desired, it may be advantageous to additionally employ the at least one transversal optical sensor 184 which may provide at least one transversal sensor signal. For potential embodiments of the transversal optical sensor, reference may be made to WO 2014/097181 A1. Accordingly, the transversal optical sensor 184 may be a photo detector having at least one first electrode, at least one second electrode and at least one photovoltaic material, wherein the photovoltaic material, preferably, one or more dye-sensitized organic solar cells, such as one or more solid dye-sensitized organic solar cells, may be embedded in between the first electrode and the second electrode.

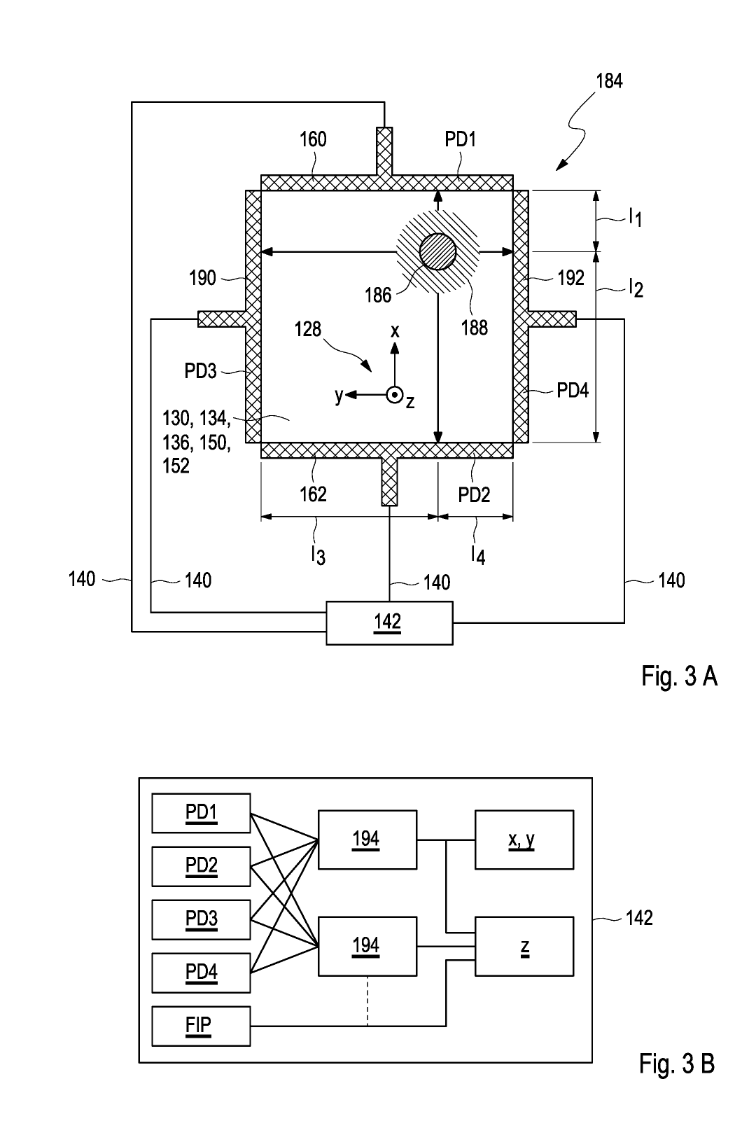

In contrast to this known embodiment, FIG. 3A illustrates a further kind of transversal optical sensor 184 in accordance with the present invention. Herein, an illumination of the sensor region 130 of the transversal optical sensor 184 comprising the thermoelectric unit 134 by the light beam 132 is shown. Preferably, the thermoelectric unit 134 in the sensor region 130 may comprise the thermoelectric material 136, in particular, in form of the layer 152 of one of the pyroelectric materials 150 as described above. In FIG. 3A, two different situations are depicted, representing different distances between the object 112, from which the light beam 132 propagates towards the detector 110, and the detector 110 itself, resulting in two different beam cross-sections 158 as generated by the light beam 132 in the sensor region 130, firstly, a small light spot 186 and, secondly, a large light spot 188. In both cases, the overall power of the light beam 132 remains the same over the light spots 186, 188. Consequently, the average intensity in the small light spot 186 is significantly higher than in the large light spot 188. Further, in both cases a position of a center of the light spots 186, 188 remains unaltered, irrespective of a size of the light spots 186, 188. This feature demonstrates the capability of the T-shaped electrodes 160, 162, 190, 192 and the corresponding signal leads 140 of the transversal optical sensor 184 as illustrated here to provide transversal sensor signals to the evaluation device 142, which are configured to allow the evaluation device 142 unambiguously determining the at least one transversal coordinate x, y of the object 112.

If a bias voltage source (not depicted here) may be connected to the T-shaped electrodes 160, 162, 190, 192, currents I1, I2, I3 and/or I4 may be flowing between the bias voltage and the electrodes 160, 162, 190, 192. The evaluation device 142 as schematically and symbolically depicted in FIG. 3B, may, thus, be designed to evaluate the transversal sensor signals which, therein, are represented by the symbols PD1-PD4 for the transversal sensor signals and FiP for a longitudinal sensor signal. The sensor signals may be evaluated by the evaluation device 142 in various ways in order to derive a position information and/or a geometrical information on the object 112. Thus, as outlined above, at least one transversal coordinate x, y may be derived. This is mainly due to the fact that the distances between the center of the light spots 186, 188 and the electrodes 160, 162, 190, 192 are non-equal. Thus, the center of the light spot 186, 188 has a distance from the electrical contact 160 of I1, a distance from the electrical contact 162 of I2, a distance from the electrical contact 190 of I3, and a distance from the electrical contact 192 of I4. Due to these differences in the distances between the location of the light spot 186, 188 and the electrodes 160, 162, 190, 192, the transversal sensor signals will differ.

The comparison of the sensor signals may take place in various ways. Thus, generally, the evaluation device 142 may be designed to compare the transversal sensor signals in order to derive the at least one transversal coordinate of the object 112 or of the light spot 186, 188. As an example, the evaluation device 142 may comprise at least one subtracting device 194 and/or any other device which provides a function which is dependent on at least one transversal coordinate, such as on the coordinates x, y. For exemplary embodiments, the subtracting device 194 may be designed to generate at least one difference signal for one or each of dimensions x, y in FIG. 5. As an example, a simple difference between PD1 and PD2, such as (PD1−PD2)/(PD1+PD2), may be used as a measure for the x-coordinate, and a difference between PD3 and PD4, such as (PD3−PD4)/(PD3+PD4), may be used as a measure for the y-coordinate. A transformation of the transversal coordinates of the light spot 186, 188 in the sensor region 130, e.g. into transversal coordinates of the object 112 from which the light beam 132 propagates towards the detector 110, may be made by using the well-known lens equation. For further details, as an example, reference may be made to one or more of the above-mentioned prior art documents, such as to WO 2014/097181 A1.

It shall be noted, however, that other transformations or other algorithms for processing the sensor signals by the evaluation device 142 may be possible. Thus, besides subtractions or the near combinations with positive or negative coefficients, nonlinear transformations are generally feasible. As an example, for transforming the sensor signals into z-coordinates and/or x, y-coordinates, one or more known or determinable relationships may be used, which, as an example, may be derived empirically, such as by calibrating experiments with the object 112 placed at various distances from the detector 110 and/or by calibrating experiments with the object 112 placed at various transversal positions or three-dimensional positions, and by recording the respective sensor signals.

As already outlined above, the longitudinal coordinate z may be also derived, in particular by implementing the FiP effect explained in further detail in WO 2012/110924 A1 and/or in WO 2014/097181 A1. For this purpose, the at least one longitudinal sensor signal as provided by the FIP sensor may be evaluated by using the evaluation device 142 and determining, therefrom, the at least one longitudinal coordinate z of the object 112.

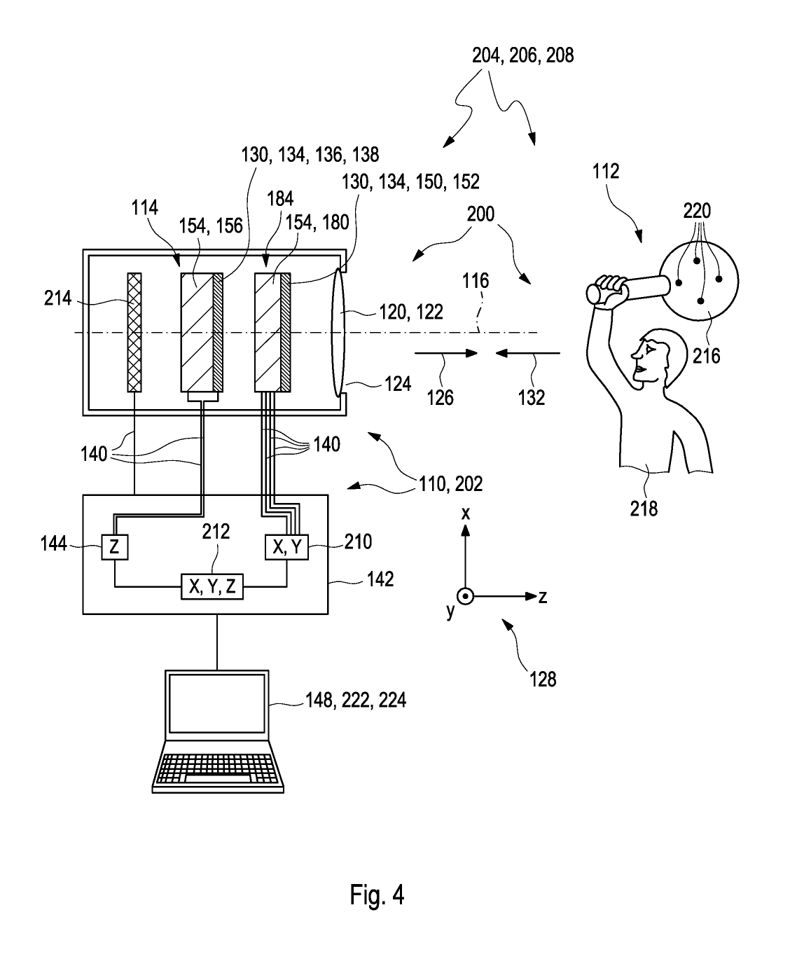

As an example, FIG. 4 shows an exemplary embodiment of a detector system 200, comprising at least one optical detector 110, such as the optical detector 110 as disclosed in FIG. 1, wherein the optical detector 110 may, preferably, comprise the longitudinal optical sensor 114 according to any one of the embodiments as shown in FIGS. 2A and 2B as well as the transversal optical sensor 184 according to the embodiment of FIG. 3A. Herein, the optical detector 110 may be employed as a camera 202, specifically for 3D imaging, which may be made for acquiring images and/or image sequences, such as digital video clips. Further, FIG. 4 shows an exemplary embodiment of a human-machine interface 204, which comprises the at least one detector 110 and/or the at least one detector system 200, and, further, an exemplary embodiment of an entertainment device 206 comprising the human-machine interface 204. FIG. 4 further shows an embodiment of a tracking system 208 adapted for tracking a position of at least one object 112, which comprises the detector 110 and/or the detector system 200.

With regard to the optical detector 110 and to the detector system 200, reference may be made to the full disclosure of this application. Basically, all potential embodiments of the detector 110 may also be embodied in the embodiment shown in FIG. 4. The evaluation device 142 may be connected to the longitudinal optical sensor 114, in particular, by using the signal leads 140. Herein, the optical detector 110 may, preferably, comprise the longitudinal optical sensor 114 according to any one of the embodiments as illustrated in FIGS. 2A and 2B, in particular one of a thermoelectric material 136 or a thermoelectric device 138. As described above, a use of two or, preferably, three longitudinal optical sensors 114 may support the evaluation of the longitudinal sensor signals without any remaining ambiguity. The evaluation device 142 may further be connected to transversal optical sensor 184, preferably to the transversal optical sensor 184 according to the embodiment as illustrated in FIG. 3A, in particular, by the signal leads 140. By way of example, the signal leads 140 may be provided and/or one or more interfaces, which may be wireless interfaces and/or wire-bound interfaces. Further, the signal leads 140 may comprise one or more drivers and/or one or more measurement devices for generating sensor signals and/or for modifying sensor signals. Further, again, the at least one transfer device 120 may be provided, in particular as the refractive lens 122 or convex mirror. The optical detector 110 may further comprise the at least one housing 118 which, as an example, may encase one or more of components 114, 184.

Further, the evaluation device 142 may fully or partially be integrated into the optical sensors 114, 184 and/or into other components of the optical detector 110. The evaluation device 142 may also be enclosed into housing 118 and/or into a separate housing. The evaluation device 142 may comprise one or more electronic devices and/or one or more software components, in order to evaluate the sensor signals, which are symbolically denoted by the longitudinal evaluation unit 144 (denoted by “z”) and a transversal evaluation unit 210 (denoted by “xy”) and. By combining results derived by these evaluation units 144, 210, a position information 212, preferably a three-dimensional position information, may be generated (denoted by “x, y, z”).

Further, the optical detector 110 and/or to the detector system 200 may comprise an imaging device 214 which may be configured in various ways. Thus, as depicted in FIG. 4, the imaging device 214 can for example be part of the detector 110 within the detector housing 118. Herein, the imaging device signal may be transmitted by one or more imaging device signal leads 140 to the evaluation device 142 of the detector 110. Alternatively, the imaging device 214 may be separately located outside the detector housing 118. The imaging device 214 may be fully or partially transparent or intransparent. The imaging device 214 may be or may comprise an organic imaging device or an inorganic imaging device. Preferably, the imaging device 214 may comprise at least one matrix of pixels, wherein the matrix of pixels may particularly be selected from the group consisting of: an inorganic semiconductor sensor device such as a CCD chip and/or a CMOS chip; an organic semiconductor sensor device.

In the exemplary embodiment as shown in FIG. 4, the object 112 to be detected, as an example, may be designed as an article of sports equipment and/or may form a control element 216, the position and/or orientation of which may be manipulated by a user 218. Thus, generally, in the embodiment shown in FIG. 4 or in any other embodiment of the detector system 200, the human-machine interface 204, the entertainment device 206 or the tracking system 208, the object 112 itself may be part of the named devices and, specifically, may comprise the at least one control element 216, specifically, wherein the at least one control element 216 has one or more beacon devices 220, wherein a position and/or orientation of the control element 216 preferably may be manipulated by user 218. As an example, the object 112 may be or may comprise one or more of a bat, a racket, a club or any other article of sports equipment and/or fake sports equipment. Other types of objects 112 are possible. Further, the user 218 may be considered as the object 112, the position of which shall be detected. As an example, the user 218 may carry one or more of the beacon devices 220 attached directly or indirectly to his or her body.

The optical detector 110 may be adapted to determine at least one item on a longitudinal position of one or more of the beacon devices 220 and, optionally, at least one item of information regarding a transversal position thereof, and/or at least one other item of information regarding the longitudinal position of the object 112 and, optionally, at least one item of information regarding a transversal position of the object 112. Particularly, the optical detector 110 may be adapted for identifying colors and/or for imaging the object 112, such as different colors of the object 112, more particularly, the color of the beacon devices 220 which might comprise different colors. The opening 124 in the housing 118, which, preferably, may be located concentrically with regard to the optical axis 116 of the detector 110, may preferably define a direction of a view 126 of the optical detector 110.

The optical detector 110 may be adapted for determining the position of the at least one object 112. Additionally, the optical detector 110, specifically an embodiment including the camera 202, may be adapted for acquiring at least one image of the object 112, preferably a 3D-image. As outlined above, the determination of a position of the object 112 and/or a part thereof by using the optical detector 110 and/or the detector system 200 may be used for providing a human-machine interface 204, in order to provide at least one item of information to a machine 222. In the embodiments schematically depicted in FIG. 4, the machine 222 may be or may comprise at least one computer and/or a computer system comprising the data processing device 148. Other embodiments are feasible. The evaluation device 142 may be a computer and/or may comprise a computer and/or may fully or partially be embodied as a separate device and/or may fully or partially be integrated into the machine 222, particularly the computer. The same holds true for a track controller 224 of the tracking system 208, which may fully or partially form a part of the evaluation device 142 and/or the machine 222.

Similarly, as outlined above, the human-machine interface 204 may form part of the entertainment device 206. Thus, by means of the user 218 functioning as the object 112 and/or by means of the user 218 handling the object 112 and/or the control element 216 functioning as the object 112, the user 218 may input at least one item of information, such as at least one control command, into the machine 222, particularly the computer, thereby varying the entertainment function, such as controlling the course of a computer game.

As outlined above, the detector 110 may have a straight beam path or a tilted beam path, an angulated beam path, a branched beam path, a deflected or split beam path or other types of beam paths. Further, the light beam 132 may propagate along each beam path or partial beam path once or repeatedly, unidirectionally or bidirectionally. Thereby, the components listed above or the optional further components listed in further detail below may fully or partially be located in front of the longitudinal optical sensors 114 and/or behind the longitudinal optical sensors 114.

### LIST OF REFERENCE NUMBERS

110 detector

112 object

114 longitudinal optical sensor

116 optical axis

118 housing

120 transfer device

122 refractive lens

124 opening

126 direction of view

128 coordinate system

130 sensor region

132 light beam

134 thermoelectric unit

136 thermoelectric material

138 thermoelectric device

140 signal leads

142 evaluation device

144 longitudinal evaluation unit

146 illumination source

148 processing device

150 pyroelectric material

152 layer

154 substrate

156 transparent substrate

158 beam cross-section (spot size)

160, 162 electrodes

164 thermopile

166 thermocouple

168, 170 electrical conductor

172 n-type conducting material

174 p-type conducting material

176 first kind of the electrical junction (hot junction)

178 second kind of the electrical junction (cold junction)

180 heat sink

182 optical band-pass filter

184 transversal optical sensor

186 small spot

188 large spot

190, 192 electrical contacts

194 subtracting device

200 detector system

202 camera

204 human-machine interface

206 entertainment device

208 tracking system

210 transversal evaluation unit

212 position information

214 imaging device

216 control element

218 user

220 beacon device

222 machine

224 track controller

1-15. (canceled)

16. A detector for an optical detection of at least one object, comprising:
at least one longitudinal optical sensor including at least one sensor region, and configured to generate at least one longitudinal sensor signal dependent on an illumination of the sensor region by a light beam, wherein the longitudinal sensor signal, given same total power of the illumination, is dependent on a beam cross-section of the light beam in the sensor region, wherein the sensor region comprises at least one thermoelectric unit, wherein the thermoelectric unit is configured, upon illumination of the sensor region or a part thereof by the light beam, to generate the longitudinal sensor signal as a result of at least one of a spatial variation or a temporal variation of a temperature in the thermoelectric unit; and
at least one evaluation device configured to generate at least one item of information on a longitudinal position of the object by evaluating the longitudinal sensor signal.

17. The detector according to claim 16, wherein the thermoelectric unit comprises at least one of a thermoelectric material or a thermoelectric device.

18. The detector according to claim 17, wherein the thermoelectric material comprises at least one pyroelectric material, wherein temporal variation of the temperature in the pyroelectric material can generate the longitudinal sensor signal.

19. The detector according to claim 18, wherein the pyroelectric material comprises at least one of lithium tantalate (LiTaO3), gallium nitride, cesium nitrate (CsNO3), lead zirconate titanate (Pb[ZrₓTi₁₋ₓ]O₃, wherein 0<x<1), a polyvinyl fluoride, a phenylpyridine derivatives, cobalt phthalocyanine, L-alanine, triglycine sulfate, a mixture and/or a doped variant thereof.

20. The detector according to claim 18, wherein the pyroelectric material is provided as a layer of the pyroelectric material.

21. The detector according to claim 17, wherein the thermoelectric device comprises at least one thermocouple, wherein the thermocouple comprises at least two different kinds of electrical conductors, wherein the different kinds of the electrical conductors are configured to form at least two spatially separated electrical junctions, wherein, upon a temperature difference between at least one of the spatially separated electrical junctions, a voltage is generated between the spatially separated electrical junctions.

22. The detector according to claim 21, wherein the thermoelectric device comprises a thermopile, wherein the thermopile comprises a multitude of thermocouples, wherein the multitude of the thermocouples is arranged in series.

23. The detector according to claim 21, wherein the at least one thermocouple is configured in the sensor region so that the light beam can illuminate a first kind of the electrical junctions, wherein the second kind of the electrical junctions is connected to a heat sink, wherein the longitudinal sensor signal comprises an output voltage between the first kind of the electrical junctions and the second kind of the electrical junctions in the thermocouple.

24. The detector according to claim 21, wherein the electrical conductors comprise a thin film of an electrically conducting material.

25. The detector according to claim 24, wherein the electrical conductors comprise an alternating arrangement of an n-type conducting material and a p-type conducting material.

26. The detector according to claim 25, wherein the n-type conducting material comprises at least one of Sb or n-type Si, and wherein the p-type conducting material comprises at least one of Bi, Au, Al, or p-type Si.

27. The detector according to claim 16, further comprising:
at least one transversal optical sensor configured to determine a transversal position of the light beam traveling from the object to the detector, the transversal position being a position in at least one dimension perpendicular to an optical axis of the detector, the transversal optical sensor configured to generate at least one transversal sensor signal,
wherein the transversal optical sensor comprises at least one further thermoelectric unit,
wherein, upon illumination of the further thermoelectric unit by the light beam, at least one of a spatial variation or a temporal variation of the temperature in the further thermoelectric unit is configured to generate the transversal sensor signal, wherein the evaluation device is further configured to generate at least one item of information on a transversal position of the object by evaluating the transversal sensor signal.

28. The detector according to claim 27, wherein the further thermoelectric unit comprises at least one pyroelectric material provided as a layer of the pyroelectric material, wherein the transversal optical sensor further comprises at least two electrodes contacting the pyroelectric material, wherein the electrodes are configured to provide the at least one transversal sensor signal.

29. A method for an optical detection of at least one object, comprising:
generating at least one longitudinal sensor signal by using at least one longitudinal optical sensor including at least one sensor region, wherein the at least one longitudinal sensor signal is generated dependent on an illumination of the sensor region by a light beam, wherein the longitudinal sensor signal, given same total power of the illumination, is dependent on a beam cross-section of the light beam in the sensor region, wherein the sensor region comprises at least one thermoelectric unit, wherein, upon illumination of the sensor region or a part thereof by the light beam, at least one of a spatial variation or a temporal variation of the temperature in the thermoelectric unit is designed to generate the longitudinal sensor signal; and
generating at least one item of information on a longitudinal position of the object by evaluating the longitudinal sensor signal.

30. The use of a detector according to claim 16, for a purpose of use, selected from the group consisting of: gas sensing, fire detection, flame detection, heat detection, smoke detection, combustion monitoring, spectroscopy, temperature sensing, motion sensing, industrial monitoring, chemical sensing, exhaust gas monitoring, a distance measurement, a position measurement, an entertainment application, a security application, a human-machine interface application, a tracking application, a scanning application, stereoscopic vision, a photography application, an imaging application or camera application, a mapping application for generating maps of at least one space, a homing or tracking beacon detector for vehicles, a distance and/or position measurement of objects with a thermal signature, a machine vision application, a robotic application, a logistics application.
